(19) United States
(12) Patent Application Publication
(10) Pub. No.: US 2014/0222522 A1
(43) Pub. Date: Aug. 7, 2014

(54) INTELLIGENT MANAGEMENT AND COMPLIANCE VERIFICATION IN DISTRIBUTED WORK FLOW ENVIRONMENTS

(71) Applicant: IBMS, LLC, Beverly Hills, CA (US)

(72) Inventor: Mitchell Barry Chait, Las Vegas, NV (US)

(73) Assignee: IBMS, LLC, Beverly Hills, CA (US)

(21) Appl. No.: 13/762,109

(22) Filed: Feb. 7, 2013

(51) Int. Cl. G06Q 10/06

(52) U.S. Cl. CPC G06Q 10/0637
USPC 705/7.36

(57) ABSTRACT

Techniques for intelligently monitoring and verifying compliance in a distributed work environment. Sensors are configured to collect various data, including human behavioral data, related to the distributed work environment. A rules engine correlates the human behavioral data with other types of data collected from sensors, and analyzes the aggregate data to determine compliance with a set of standards. Other types of data may include machine data, biological and environmental data, logistical data, and operational data. The standards may include governmental regulations, industry standards, and company specifications. The rules engine estimates a current and/or future status of a parameter of the distributed work environment, and determines whether the parameter status satisfies the standards. If the rules engine detects non-compliance and/or potential non-compliance, it generates alerts and/or remediation instructions, and/or automatically implements corrective action(s) to resolve the non-compliance using machine-to-machine interactions.

### BACKGROUND

Numerous industries rely on distributed work environments, in which operations are delegated among multiple workers and/or entities. As examples, the food industry relies on a distributed network of entities, such as farms, warehouses, transporters, processors, packagers, distributors and consumer outlets, each entity and its related workforce typically responsible for handling particular operations and/or products within an end-to-end food supply chain; the medical industry relies on a distributed network of entities, such as medical offices, hospitals, pharmacies, suppliers, and ambulances, each entity and its related workforce typically responsible for providing particular operations and/or products for the care of patients; the airline industry relies on a distributed network of entities, such as booking agencies, carriers, equipment, maintenance, gate services, ground services, and tower services, each entity and its related workforce typically responsible for providing particular operations and/or products for care of passengers.

### SUMMARY

In many distributed work environments, operations and/or products that influence the protection of societies, humans, animals, currencies, securities, and commercial organizations are usually subject to government regulations, industry standards, management policies, and/or purchaser specifications. Such distributed environments typically rely on the actions and judgment of numerous human workers to ensure that operations comply with such regulations and policies. Even in environments in which computers are utilized to automate certain operations, humans are typically responsible for the information input into the computers and/or acting upon the information output from the computers. In each instance, human intervention is inevitable, and the risk of human error and/or tampering is existent.

As a specific example, many food industries typically rely on a food supply chain that begins with a whole food producer (raw materials) and manufacturer, such as a farm or factory, which ultimately produces food products. The food products may be a result of a blend of raw materials and/or products that are stored in one or more storage facilities. Transportation systems transport the food products to various wholesale and/or retail distribution centers, from which retailers are able to procure desired food products to sell to consumers. In many cases, a food supply chain is required to comply with governmental safety regulations, such as maintaining certain foods within a temperature-controlled environment. This is referred to as a “cold chain.” For example, under the Food and Drug Administration (FDA) Final Egg Rule, an egg farm is required to hold and transport eggs at or below a 45° F. ambient temperature beginning 36 hours after time of lay. A cold chain requires each entity involved in the end-to-end perishable food supply chain to maintain a given temperature range during its operations, such as storage and transportation, to ensure the safety, stability and shelf life of the food products.

The inventors have recognized and appreciated techniques for intelligently implementing compliance in a distributed work environment. The inventors have recognized and appreciated that an integrated system that analyzes diverse data collected from different types of operations may provide a more accurate and holistic analysis of the distributed work environment. In some embodiments, the intelligent system may adaptively learn and predictively determine actions to resolve non-compliance and/or mitigate potential non-compliance. In some embodiments, an intelligent behavior management system may monitor and analyze data collected from various sensors, and take actions to ensure the resolution of detected non-compliance. The resolution may involve generating different/elevated types of alerts or instructions and/or reconfiguring one or more operations of the work environment. The inventors have recognized and appreciated that such a system may enable proactive management of resources that improves efficiency and/or safety in a distributed work environment.

One embodiment is directed to a method of monitoring, managing, and instrumenting a distributed work environment. The method comprises receiving data, wherein the data represents or is related to one or more of: behavior of one or more persons responsible for taking action in the distributed work environment, biological or environmental parameters associated with the distributed work environment, operational conditions and/or events, apparatus usage and/or condition, one or more standards and degree of compliance therewith, or product production and/or delivery logistics. The method further comprises using at least one processor to process at least part of the data; determine, based on the processing of at least part of the data, whether a parameter status satisfies at least one standard; and output at least one result based on determining whether the status satisfies the at least one standard.

Another embodiment is directed to at least one computer-readable medium having stored thereon computer-readable program instructions. The computer-readable program instructions, when executed by at least one processor, perform acts of receiving data, wherein the data represents or is related to one or more of: behavior of one or more persons responsible for taking action in the distributed work environment, biological or environmental parameters associated with the distributed work environment, operational conditions and/or events, apparatus usage and/or condition, one or more standards and degree of compliance therewith, or product production and/or delivery logistics. The computer-readable program instructions, when executed by at least one processor, further perform acts of processing at least part of the data; determining, based on the processing of at least part of the data, whether a parameter status satisfies at least one standard; and outputting at least one result based on determining whether the status satisfies the at least one standard.

Another embodiment is directed to a method of end-to-end monitoring of a distributed work environment from a starting point to an ending point. The method comprises receiving data that emanates from critical points within the distributed work environment. The data represents or is related to one or more of: behavior of one or more persons responsible for taking action in the distributed work environment, biological or environmental parameters associated with the distributed work environment, operational conditions and/or events, apparatus usage and/or condition, one or more standards and degree of compliance therewith, or product production and/or delivery logistics. The method further comprises using at least one processor to process at least part of the data; determine, based on the processing of at least part of the data, whether a parameter status of the distributed work environment satisfies at least one standard; and output at least one result based on determining whether the parameter status satisfies the at least one standard.

It should be appreciated that all combinations of the foregoing concepts and additional concepts discussed in greater detail below (provided that such concepts are not mutually inconsistent) are contemplated as being part of the inventive subject matter disclosed herein.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic illustration of an example of an intelligent behavior management system in which some embodiments may be implemented;

FIG. 2 is a schematic illustration of an example of intelligent behavior management of a food supply cold chain, in accordance with some embodiments;

FIG. 3 is a schematic illustration of an example of a data store configured to store sensor data and standards, in accordance with some embodiments;

FIG. 4 is a flow chart of an example of processing performed by an intelligent behavior management system, in accordance with some embodiments;

FIG. 5 is a flow chart of an example of processing performed by a rules engine, in accordance with some embodiments;

FIG. 6 is a functional block diagram of an example of interactions between different entities in a domain, in accordance with some embodiments;

FIG. 7 is a schematic illustration of the roles at various levels across the platform and solutions that are a part of a distributed work environment, according to some embodiments;

FIG. 8 is a schematic illustration of an example of an internal supply chain in the context of a food supply system, according to some embodiments;

FIG. 9 is a schematic illustration of an example of partner alliances that may be established between businesses; according to some embodiments;

FIG. 10 is a schematic illustration of policy inheritance and association in partner alliances, according to some embodiments;

FIG. 11 is a schematic illustration of an example of data flow in a compliance management system, according to some embodiments;

FIG. 12 is a schematic illustration of an overall architecture of an example compliance management system, according to some embodiments;

FIG. 13 is a schematic illustration of an example connectivity graph for one possible supply chain network, according to some embodiments;

FIG. 14 is a schematic illustration of an example of both fine-grained tracking and coarse-grained tracking, according to some embodiments;

FIG. 15 is a schematic illustration of an example of a portion of the compliance management system detailing how observations of Touchpoints may be captured into a backend storage, according to some embodiments; and

FIG. 16 is an example of a computing system on which some embodiments may be implemented.

### DETAILED DESCRIPTION

The inventors have recognized and appreciated that significant advances in the efficiency, safety, and accountability of distributed work environments may be achieved with an intelligent behavior management system that identifies and resolves errors and/or fraud, and that such a system may be achieved by analyzing data collected by sensors, including human behavioral data, to detect existing and/or potential non-compliance with a set of instructions and/or prescribed standards, and takes actions to ensure resolution of non-compliance. In some embodiments, if non-compliance is detected, the system may generate alerts, recommend remediation instructions, and/or reconfigure operations and/or machines to implement compliance in the distributed work environment.

In some embodiments, the system may take action on its own to resolve a detected non-compliance. For example, in some embodiments, the system may be configured to automatically implement one or more corrective actions using machine-to-machine interactions to reconfigure the operations and/or machinery of the work environment. For example, in some embodiments, the system may generate alerts and, if no response or action is detected in response to alerts, generate elevated alerts to different authorities and/or implement actions on its own. In some embodiments, if a non-compliance is correctable by machine-to-machine interactions, then the system may automatically take action(s) to re-configure the operations of the work environment towards compliance. This may occur without substantial human intervention, in which case the system may simply generate indications of the re-configured operations and/or the source of non-compliance.

As a non-limiting example, in the context of a food supply chain, if a particular truck carrying a shipment is detected to be non-compliant with a required cold chain, then the system may automatically take action by terminating the shipment or contract and automatically ordering a replacement shipment, either from the same source or a different source. As such, a non-compliant event, which could otherwise cause disruptions that propagate to other parts of the distributed work environment, may be proactively detected and seamlessly resolved by the system. The system may thus reduce latency and improve efficiency by reducing the reliance on human intervention, by monitoring, analyzing, predicting, and implementing appropriate solutions on a real-time basis using machine-to-machine interactions.

As another non-limiting example, in the context of a retail environment, the price of a purchased item at a point-of-sale location may not be compliant with a company's price margin policy (whether by human input error by a cashier, or by incorrect pricing of the item in the store's computer system). Upon scanning the bar code of the item, the intelligent management system may detect that the price is not compliant with the company's margin policy, and may also determine that there are no other existing policies that override the company's margin policy. Based on this analysis, the system may generate an alert, either to the cashier, management, or other suitable entity. In some embodiments, if the alert is not acted upon, then the system may generate elevated alerts to different entities and/or take action on its own to automatically adjust the point-of-sale price and finish the transaction.

It should be appreciated, however, that embodiments are not limited to these particular examples, nor to any particular action(s) upon detecting non-compliance, as the system may be used in any suitable distributed work environment, and may take any suitable action(s) to help ensure compliance with a prescribed set of rules. Furthermore, in some embodiments, the degree to which the intelligent system automatically takes corrective may be adjusted based on preference (e.g., by a manager, a customer, etc.). Regardless of the exact nature of actions taken by the system in response to detecting non-compliance, the system may be configured to implement appropriate action(s) to help ensure resolution of the non-compliance, based on information gathered from one or more sensors and rules provided by one or more entities.

It should also be appreciated that the distributed work environment may be in any suitable industry, as embodiments are not limited to any particular type of work performed by the work environment. The work environment may generate any suitable end result, such as a physical product, a service, profits/shares, or any suitable result that is desired by customers. Regardless of the exact nature of the end result generated by the work environment, one or more characteristics of the end result may be controlled and regulated by a set of rules.

The inventors have recognized and appreciated an intelligent system that provides a suitable entity, such as those who are entitled to receive and/or regulate the end result, with a desired level of transparency and detail into the compliance of one or more parts, or the entirety, of the distributed work environment. For example, in some embodiments, the system may analyze data collected from the work environment to generate various types of information regarding compliance of the distributed work environment, which may be viewed by third-party entities, such as customers, suppliers, regulatory agencies, or any other suitable entity that has the right to such information.

In some embodiments, different types of sensors may be used to collect a variety of data. For example, in addition to human behavioral data, sensors may be configured to collect machine data, biological data, and/or environmental data, just to name a few non-limiting examples. Sensors may comprise meters, gauges, cameras, microphones, motion detectors, or any other suitable type of device that is able to collect data that may be relevant to operations in a distributed work environment.

In some embodiments, human behavioral data may be correlated with other types of data to detect patterns of inconsistency, error, and/or fraud that may indicate non-compliance with instructions or standards. In some embodiments, the standards may comprise rules and/or instructions provided by a suitable entity, such as a governmental agency, an industry group, and/or a specific company. The system may analyze and correlate data collected from potentially diverse industries and types of work. Such an integrated system may enable monitoring and management of operations throughout a distributed work environment. It should be appreciated, however, that embodiments are not limited to any particular type of collected data and standards, as any suitable data and standards may be used as a basis for determining compliance of human behavior.

In some embodiments, the system may adaptively learn and understand what human workers need to do, and if it detects non-compliance and/or non-responsiveness, it may generate elevated alerts to supervisors and/or automatically reconfigure machines and/or operations in the distributed work environment to resolve the non-compliance. The inventors have recognized and appreciated that such a system may enable proactive and integrated management of various resources and operations in a distributed work environment. As non-limiting examples, the management may include management of human workers, machine operations, and/or organizations or entities.

Many distributed work environments involve a work force and/or entities supported by machines. Intrinsic in many human/machine relationships is the dependency upon human input, interpretation, and discretion. Machines are typically programmed to receive and/or retrieve, hold, and/or calculate data to produce and make accessible information for human consumption. Dependent on circumstances, and no matter how critical it may be, there is often latency in the distribution of information to relevant members of a work force and/or entities. Such relevant members of a work force and/or entities may be referred to as “first responders.”

Workforces enable work environments and work activities that ultimately are responsible for producing a resultant product, service, and/or event, and in which such production is conducted in accordance with market requirement specifications. Common with workforces is a hierarchy of authority and responsibility. From the top down, work force policies and controls are often created and delegated to workforces through a chain of command. Standard operating procedures, which govern the workforce operations, and specifications, which govern the market requirements of a particular product, service and/or event, include safety and quality processes, which are designed to comply with, for example, company polices, government regulations, industry standards, customer specifications, and much more. One of the risks associated with governances and workforces is human intervention. Human intervention may lead to human discretion and human error—and consequently imposes onto industry and consumers, tremendous safety and economic risks.

Many activities and tasks involved in distributed workflow environments are typically influenced by human discretion and decision-making, and such human discretion is often subject to various factors, such as bias, state of mind, emotions, physical conditions, or other factors internal or external to the human workers. Variability in factors that affect human discretion may lead to human error in performing one or more tasks in a distributed work environment. The inventors have recognized and appreciated that an automated system that monitors and manages compliance in a distributed work environment may reduce such human errors by reducing the dependence on human discretion and action when performing certain tasks. As such, the intelligent behavior management system may be able to handle complex situations involving many variables and factors, efficiently and quickly process the information, and generate and implement decisions on how to best manage the situations.

In some embodiments, the inventors have recognized and appreciated that an intelligent behavior management system may enable proactive management of workers. For example, different workers may be monitored while performing particular tasks to determine whether they are performing the tasks pursuant to a set of instructions and/or standards. The system may be able to automatically detect error and/or fraud by correlating human behavioral data with other types of sensor data. As a non-limiting example, if a worker tries to manipulate machine records in a manner that is inconsistent with data collected by human behavioral sensors and/or machine sensors, then the system may detect the non-compliance, alert an appropriate person or entity and/or implement one or more machine-to-machine interactions to resolve the non-compliance.

The inventors have recognized and appreciated that such an intelligent behavior management system may mitigate difficulties in controlling a multitude of workers and/or entities in a distributed work environment. In some embodiments, the system may be provided with, or may dynamically learn, the tasks assigned to different workers and, based on collected data, may dynamically learn the capabilities of the workers. The inventors have recognized and appreciated that such a system may improve efficiency and productivity by enabling improved coordination and allocation of resources among different workers and/or entities, providing faster and more accurate decision-making and responses to problems.

The intelligent behavior management system may be able to cross-correlate, in a real-time manner, rules and specifications provided by different sources. For example, a company with multiple customers may be constrained to meet different specifications for each customer for the same product. Alternatively or additionally, the company may be required to follow different regulations from federal, state, or internal company policies for the same product. For example, an egg farm may have different customers that each require different types of testing for the safety of eggs, such as more/less frequent tests or different types of tests. The intelligent behavior management system may be able to digest such varied specifications and regulations and implement a rules engine that determines appropriate recommendations and instructions to different parts of the distributed work force based on ever-changing specifications, rules, and regulations, from potentially a variety of different sources.

In some embodiments, such a real-time rules engine may reduce the effects of human latency that often plagues distributed workflow environments, by enabling more direct machine-to-machine or machine-to-human interactions. Such interactions may enable faster and more up-to-date instructions and monitoring of different parts of a distributed work force. This may improve efficiency and productivity of a distributed work environment by enabling problems to be proactively detected and mitigated automatically. In some embodiments, the system may help ensure that some human tasks are followed through to resolution by monitoring various parameters, such as time, actions, and results, and generating different types of alerts and/or remedial instructions based on detection of non-compliance or in the absence of information regarding compliance. For example, repeated failures to resolve a particular task or problem may cause increasingly elevated alerts to be generated, a wider scope of parties to whom alerts are sent, and/or other appropriate actions to automatically resolve the non-compliance using machine-to-machine interactions.

The inventors have recognized and appreciated that an intelligent behavior management system may be useful in a wide variety of industries in which work is distributed among multiple workers. As non-limiting examples, the system may be used in food production and supply, commercial airlines, hospitals, security companies, and/or the military. Regardless of the specific environment in which it is used, the system may enable real time monitoring, analysis, and/or prediction of the behavior of workers, and automated resolution of detected non-compliance. Such a system may improve overall compliance and future compliance with a given set of instructions and/or standards.

In some embodiments, the system may use data from one part of a distributed work environment to analyze compliance in another part. In the context of a supply chain, a distributor may specify a particular set of standards, chosen from thousands of specifications that must be satisfied by a transportation company transporting goods to the distributor. The distributor may receive an alert whenever non-compliance is detected with respect to any of the standards that it specified. In some embodiments, the transportation company may not know the specific set of standards chosen by the distributor, only the complete set of specifications from which the standards were chosen. As such, an integrated system may enable improved transparency by enabling cross-correlation of data between different entities and/or workers to more accurately identify sources of non-compliance.

In some embodiments, by cross-correlating data from different sensors in different parts of a distributed work environment, an intelligent behavior management system may be able to infer sources of non-compliance that may otherwise be difficult to detect by examining each part of the environment in isolation. For example, in the context of a supply chain, the system may infer, based on analyzing data collected from a variety of sensors, that the actions of a particular worker in one part of the supply chain may have resulted in a certain number of non-compliance infractions in another part of the supply chain. The system may recommend that the worker's task be assigned to someone else who, may have a better performance at the task. As such, a company may be able to make more productive work assignments and improve the overall efficiency of the distributed work environment.

The system may comprise a number of sensors, which may communicate with one or more computing devices that collect and process data collected by the sensors. In some embodiments, the computing devices may be centralized servers, although embodiments are not limited in this regard, as the computing devices may be personal computers or mobile devices. The servers may implement a rules engine, that correlates and analyzes the collected data based on instructions and/or standards. The servers may have access to one or more data stores that store data, including the collected data, data processed from the collected data, and/or instructions and standards. In some embodiments, the servers may generate alerts or remediation instructions to one or more devices based on the analysis of the collected data. In some embodiments, the servers may also communicate back to the sensors, to reconfigure and/or adapt the sensors based on collected data and analysis.

Distributed work environments are often complex due to a large number of interconnected workers and entities. Advances in sensing and communication technology have enabled a variety of different types of information to be collected. However, it may be a challenge to transform the huge amounts of data into effective decision-making, especially when some data may be incomplete or have errors. Furthermore, in some embodiments, acquiring measurements may be costly. Energy is often a limited resource and may be consumed by communication, sensing, and computation. Measurements may not be equally useful and/or may incur different resource expenditures. In some embodiments, a sensor management algorithm may determine which sensors to activate at each time to achieve a desired trade-off between management performance and communication cost.

The sensors may be configured to collect different types of data, such as human behavioral data, biological data, environmental data, and/or machine data. It should be appreciated that embodiments are not limited in the type of sensors used, as different types of data collected by different types of sensors may be correlated and analyzed by the system. The analysis may be performed by a rules engine, which implements one or more algorithms that analyze the collected data according to the specified instructions and/or standards to detect non-compliance. In some embodiments, reporting devices may be carried by workers and/or supervisors, and may provide real time alerts, recommendations, and/or instructions based on the analysis by the rules engine.

Although embodiments are not limited in the number and nature of data collected by sensors and the standards to which the data is compared, the inventors have recognized and appreciated that using at least eight different types of data and standards may improve distributed work management. The data may include: behavioral data, representing the actions and/or behavior of workers performing certain tasks; operational data, representing specific steps to be taken in operating machinery or generally performing certain tasks; biological and environmental data, representing a condition of animals and/or the surrounding environment, such as in a farm; machine data, representing any suitable data collected from machinery or equipment; and logistical data, representing information related to a distribution and supply chain, such as the handling and transfer of goods from one entity to another. In some embodiments, the standards may comprise three different types of information: regulatory rules, representing governmental regulations, such as 21 C.F.R. that regulates rodent indexing in livestock farms; industry standards, representing instructions or standards established by trade groups or industry organizations; and company specifications, representing company-specific specifications or rules regarding operation and task within the company.

It should be appreciated, however, that more or less types of data may be collected and/or analyzed, as embodiments are not limited in the amount or nature of the data. For example, in some embodiments, there may be no regulatory rules in a specific industry, or a company may not have provided any specifications, or some types of collected data may not be available, whether due to lack of sensors or due to a determination that the data is not necessary. Furthermore, it should be appreciated that embodiments are not limited to a particular industry or work environment in which the system may be used. Nonetheless, for illustrative purposes, a few non-limiting examples are provided below.

As a non-limiting example, in the context of pre-flight checks for airplanes, if the rules engine determines that the pilot of an airplane has not appropriately performed an adequate visual inspection of the outside of the plane, then the system may issue instructions to the tower to prevent liftoff of the plane until an adequate visual inspection has been performed. Such a determination may be made, for example, using motion sensors, a Global Positioning System (GPS) tracker, cameras, or other suitable sensors, that detect activities of the pilot. The sensors may be communicative with other entities in the preflight checking process, such as the tower and/or the ground crew. Sensors may also be used to monitor the activities of these other entities, and the sensors may be communicative with each other to provide real time information regarding the entire preflight check process to the entities involved. As such, one or more of the entities may have a complete view of the preflight check process, and the system may issue suitable alerts and/or instructions based on the collected data. Only when all these steps of the preflight check process have been completed, may the system issue instructions for liftoff of the airplane.

As another non-limiting example, in the context of a hospital or medical facility, drug administration to patients may be monitored and analyzed by an intelligent behavior management system. The system may store relevant data regarding patients in the hospital, and also standards and protocols that should be followed regarding patients. Sensors may collect various types of data, based on patient health conditions, which may be monitored by one or more machines. Sensors may also collect data related to the performance of hospital staff, such as interns, nurses, doctors, who may be responsible for drug administration to the patient. Various types of sensors may be used, such as RFIDs on patient wrist bands, or on hospital staff ID badges, to determine when and where certain drugs have been administered to a patient. If a member of the hospital staff tries to mistakenly administer a drug to a patient, not within a protocol of the hospital for that patient, then the system may issue an alert to the hospital staff and/or may control machinery responsible for administering the drug, to prevent the administration of the drug to the patient. Additionally or alternatively, if a member of the hospital staff tries to acquire a drug for a particular patient, not within a protocol of the hospital, then a pharmacy from which the drug is being acquired may be issued an alert or instruction not to release that drug for that patient.

As another non-limiting example, in the context of a food supply chain, a packaging facility may detect an oversupply of a food product as compared to the number and capacity of suppliers that supply the food product. In such cases, the intelligent system may analyze various types of data collected from throughout the food supply chain to determine whether alien food products may have entered the food supply chain, from sources other than the approved suppliers. Such alien food products may present a risk if they have not undergone the same level of safety testing and regulation required of the approved suppliers. Upon detecting such potential non-compliance, the system may generate one or more alerts of potential alien food products, which may be sent to the distributors, retailers, or other suitable entity. If such alerts are not acted upon, then the system may implement action(s) to prevent the distribution of food products that are potentially alien, such as by cancelling a shipment and ordering a replacement shipment from an approved supplier. Such alerts and/or actions may enable real-time identification and resolution of potentially alien food products in a food supply chain, before they are distributed to retailers and, ultimately, consumers.

As yet another non-limiting example, in the context of a fire safety and rescue environment, an integrated workflow management system may be used to provide instructions and/or alerts to members of the fire and rescue staff to improve safety and efficiency of their rescue operations. For example, the system may be provided with certain regulations and/or specifications by a medical department of the fire and rescue service, which may set protocols for the safety for the servicemen. Any suitable protocol may be specified, for example, thresholds of temperature and/or weight of equipment that may be tolerated by different servicemen, potentially based on biological data of each serviceman. The system may also have sensors that detect conditions of a rescue environment, such as the internal temperature inside of a building, or height of a particular window, that is being accessed by servicemen. The system may also have a set of specifications related to the particular building and/or structure involved. Based on this collected data, the system may provide real time alerts and/or instructions to the servicemen on actions that should or should not be taken during the rescue operation. In some embodiments, the system may also manage preventative actions for the support system, such as ensuring that there are sufficient number of standby fire planes available in a nearby harbor, making sure that equipment gets routine maintenance, or other preventative measures to improve the safety and reliability of the rescue operation. If any of the collected and analyzed data indicate non-compliance with protocols, the system may generate an alert and/or instructions indicating such non-compliance.

Regardless of the particular industry in which the system is used, and the particular data and standards analyzed, an intelligent behavior management system may enable proactive and integrated management of a distributed work environment by intelligently monitoring, analyzing, and managing human behavior within the context of the work environment.

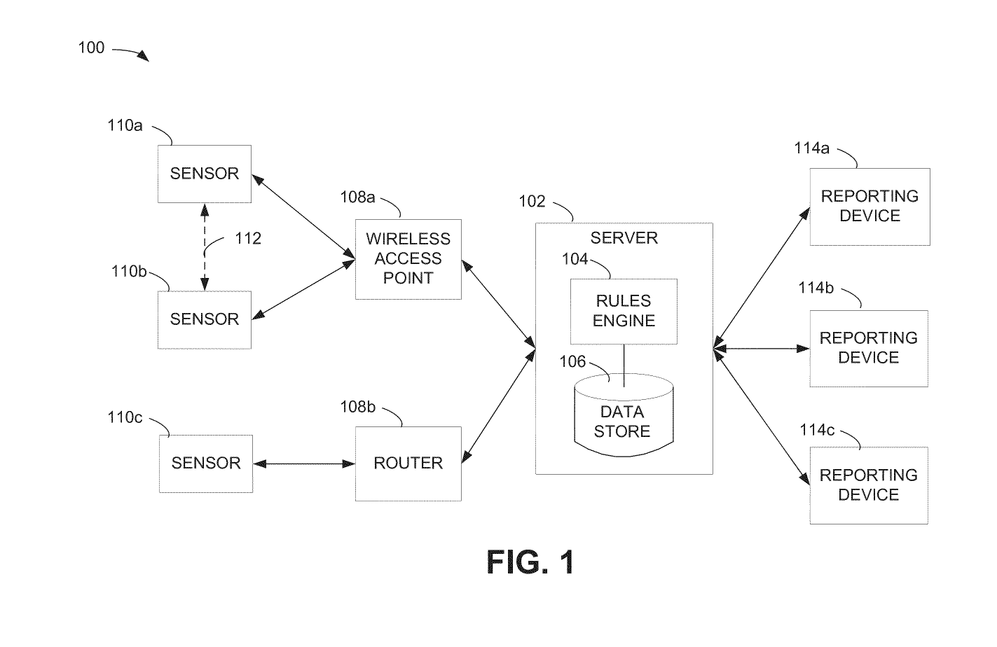

FIG. 1 is a schematic illustration of an example of an integrated workflow management system, according to some embodiments. In some embodiments, the system 100 may be used to monitor and analyze data collected from different entities involved in a distributed workflow chain, such as a cold chain in food production and supply. Though, it should be appreciated that embodiments are not limited to food production and supply and may be used in any suitable distributed work environment.

In some embodiments, system 100 may comprise a server 102 that implements a rules engine 104 and stores collected data and/or standards and instructions in a data store 106. In some embodiments, the server 102 may be a centralized server that aggregates and processes all the aggregated data, although it should be appreciated that embodiments are not limited to a single centralized server, and may implement the rules engine 104 and the data store 106 in a plurality of computing devices that may be distributed throughout the system 100.

Regardless of how the server 102 is implemented, it may be connected to one or more devices that route and/or forward information to or from the server 102. As non-limiting examples, FIG. 1 illustrates a wireless access point 108a and a router 108b that connects the server 102 with a plurality of sensors, for example, sensors 110a, 110b, 110c. The sensors 110a, 110b, 110c may be any suitable type of sensors that are adapted to collect data from their environments.

In some embodiments, one or more of sensors 110a-110c may be sensors that collect human data, such as speech, motion, location, and motion. The human data sensors may be, in some embodiments, remote sensors and/or wearable sensors. Remote sensors may include, as examples, infrared sensors that detect motion and/or location, cameras that detect motion, location, and/or facial expressions, and/or microphones that detect speech. Such remote sensors may be placed at different parts of an environment, to monitor one or more human workers performing certain tasks. Alternatively, or additionally, human data sensors may be wearable, such as modified ID badges, or personal digital assistants (PDAs). The wearable sensors may use any suitable technology, including, but not limited to, Radio Frequency Identification (RFID) tags, Global Positioning System (GPS) chips, microphones, cameras, accelerometers to detect physical activity, infrared sensors, or other suitable sensor technology.

The human behavioral sensors may, in some embodiments, detect social behavior between workers, such as face-to-face interactions, conversations, proximity, or any other suitable measure of social behavior. It should be appreciated, however, that embodiments are not limited to a particular nature of human behavioral data, as the system 100 may utilize any monitor and analyze any suitable form of human behavior relevant to operations of the distributed work environment.

In some embodiments, sensors may be configured to collect other types of data, in addition to human behavioral data. For example, in some embodiments, sensors may collected machine data. Such sensors may be, for example, meters, gauges, or actuators configured to detect one or more operational characteristics of a machine. In some embodiments, sensors may collect environmental data, such as ambient temperature, humidity, noise level, light intensity, or any other appropriate environmental characteristic pertinent to the particular environment of the operation. In some embodiments, the sensors 110a-110c may be distributed in different geographic locations, and may be operated by different entities, or may be within a common geographic location and operated the same entity.

In some embodiments, in addition to collecting data, sensors may perform processing on data collected and/or instructions received. For example, in some embodiments, sensors may perform compression on data that is collected, using techniques in compressive sensing. Such compression may enable a more compact representation of the collected data to be transmitted, thus conserving communication resources. Additionally or alternatively, compression may be performed by intermediate devices, such as a wireless access point (WAP) 108a and/or router 108b. It should be appreciated, though, that embodiments are not limited to compressive sensing, and that data may be transmitted from the sensors 110a-110c to the server 102 in the same form in which they are sensed.

In some embodiments, one or more sensors may communicate with each other. The example in FIG. 1 illustrates sensor 110a and sensor 110b communicating via communication link 112, which may be any suitable communication medium, such as wired or wireless. The information transmitted between the sensors 110a and 110b may be, for example, related to the data collected by the sensors and/or may be related to instructions sent from the server 102. In some embodiments, inter-sensor links may be used to relay information from one sensor to another, for example, to perform peer-to-peer routing between sensors that may not otherwise be directly connected to any other access point to the server 102. Additionally, or alternatively, the communication link 112 may be used to enable cooperation between sensors 110a and 110b to help improve the accuracy of data collection, for example, by cross-correlating data collected and verifying consistency.

In some embodiments, the sensors may be specifically configured to collect data that is most relevant to determining compliance with a given set of instructions and/or standards. In some embodiments, the sensors may be dynamically adjusted in real time based on the collected and analyzed data. For example, a particular sensor may be adapted to collect more and/or different data when a non-compliance is detected in the data collected by the sensor. In some embodiments, such adjustments may be made by the server 102, or by any other computing device that has access to the data collected by the sensor. In some embodiments, sensors may also have an input/output interface, such as a keyboard or a screen, to enable manual control of the sensor.

Regardless of the exact nature of the sensors 110a-110c, and the techniques by which they communicate with the server 102 and/or each other, the sensors 110a-110c may collect and transmit data to the server 102 for analysis using the rules engine 104 and storage in the data store 106. The server 102 may be configured to recognize data collected from different sensors, and analyze the different types of data using the appropriate standards applied by the rules engine 104. As such, in some embodiments, the system 100 may be able to monitor and analyze end-to-end performance in a workflow chain consisting of different entities operating in different industries, possibly with entirely different set of rules and regulations.

In some embodiments, the collected data may be stored in a computer memory, such as a data store 106. The data store 106 may be integrated with the server 102 or may comprise multiple memory locations distributed in different parts of a network. The stored data may include any of the eight types of data specified above, including human behavioral data. In some embodiments, the data store 106 may store data for different machines and/or humans involved in the distributed work environment. For example, human data may include personal attributes of a worker, general behavioral data, and/or task-specific performance data. In some embodiments, the data store 106 may be accessible by one or more other computing devices, such as by the sensors 110a-110c.

In some embodiments, the system 100 may implement the rules engine 104 configured to aggregate and analyze the different types of collected data and determine an appropriate course of action. In some embodiments, the rules engine 104 may be able to learn and make decisions in real time. In some embodiments, the rules engine 104 may be able to analyze human data, and predict how a human worker will handle a potential task, to determine whether or not to assign the task to the worker. For example, such a prediction may be made by machine learning algorithms trained with past historical data from the worker, and/or neural networks or simulations.

Regardless of the exact nature of the algorithms implemented by the rules engine 104, the rules engine 104 may be able to determine a desired plan of action based on the different types of data collected by the sensors 110a-110c. Determining a desired plan of action may be based on any suitable technique. As non-limiting examples, the rules engine 104 may perform linear/nonlinear optimization algorithms, dynamic programming, and/or Monte Carlo simulations to select one or more actions that should be performed to achieve a desired goal.

In some embodiments, the rules engine 104 may be able to cross-correlate different types of data collected by different sensors 110a-110c, some of which may be related to a common operation and/or task. Some of the sensors 110a-110c may be located at a common location, or may be distributed at different locations in different entities. Regardless of the exact location of the sensors, the rules engine 104 may be able to integrate the different types of data collected by the sensors 110a-110c and detect non-compliance and/or inconsistencies related to the operation and/or task. For example, in regards to a particular task, if some of the sensors 110a-110c collect human data and other sensors collect machine data, the rules engine 104 may be able to correlate the human data with the machine data to determine whether the particular task has been performed in compliance with designated instructions and/or standards. In some embodiments, based on the analysis of the collected data, the rules engine 104 may be able to dynamically reconfigure one or more sensors 110a-110c, for example, to collect more detailed or different types of data.

Regardless of the exact nature of the rules engine 104, different types of collected data may be analyzed and correlated with a set of standards to determine non-compliance and/or potential non-compliance, and to implement actions to resolve the non-compliance. For example, the system may provide remediation instructions and/or recommendations for future action. In some embodiments, the system may automatically re-configure one or more operations of the distributed work environment, based on the detected non-compliance.

Regardless of the exact nature of the action(s) taken by the system in response to the detected non-compliance, in some embodiments, the results of the analysis may be provided to one or more devices, such as reporting devices 114a, 114b, 114c. Although three such reporting devices are illustrated in FIG. 1, it should be appreciated that embodiments are not limited to any particular number of reporting devices, and that the use of reporting devices is optional. In some embodiments, the results of the analysis by the rules engine 104 may be provided back to the sensors 110a-110c, which may have a display or other output mechanism to provide information about the results of the rules engine 104 to an appropriate operator or supervisor.

In some embodiments, if reporting devices 114a-114c are used, then such reporting devices may be any suitable device configured to display information related to the analysis of the rules engine 104. For example, in some embodiments, reporting devices 114a-114c may include mobile devices, personal computers, or workstations. The reporting devices 114a-114c may be specially designed devices, or may be unmodified consumer devices, such as smartphones with downloaded applications, configured to display the results of the rules engine 104. In some embodiments, the reporting devices 114a-114c may have a dashboard display that allows a user to interact with the reporting devices 114a-114c. For example, the reporting devices 114a-114c may enable a user to provide feedback to the server 102 based on results of the rules engine 104. Such feedback may include, for example, specific actions or instructions that should be taken by one or more workers and/or machines, and/or requests for more data or different types of data to be collected by the sensors 110a-110c. In some embodiments, the reporting devices 114a-114c may enable a user to input new or updated standards and/or instructions to be applied by the rules engine 104.

Regardless of the exact nature of the reporting devices 114a-114c, a user operating such reporting devices may be provided with real time information regarding non-compliance and/or potential non-compliance in different parts of a distributed environment, potentially encompassing different companies and different industries. As such, the system 100 may provide an integrated real time monitoring and management capability for a distributed environment, in which problems may be detected and mitigated proactively, potentially before they propagate to other parts of the distributed environment. The heterogeneous nature of different companies involved in the distributed environment may be seamlessly integrated by the rules engine 104 that is aware of the different responsibilities of each worker and entity in the distributed chain and, in some embodiments, is able to learn behavior and trends of the different aspects of the distributed chain, to accurately predict potential sources of error and/or fraud before such problems manifest.

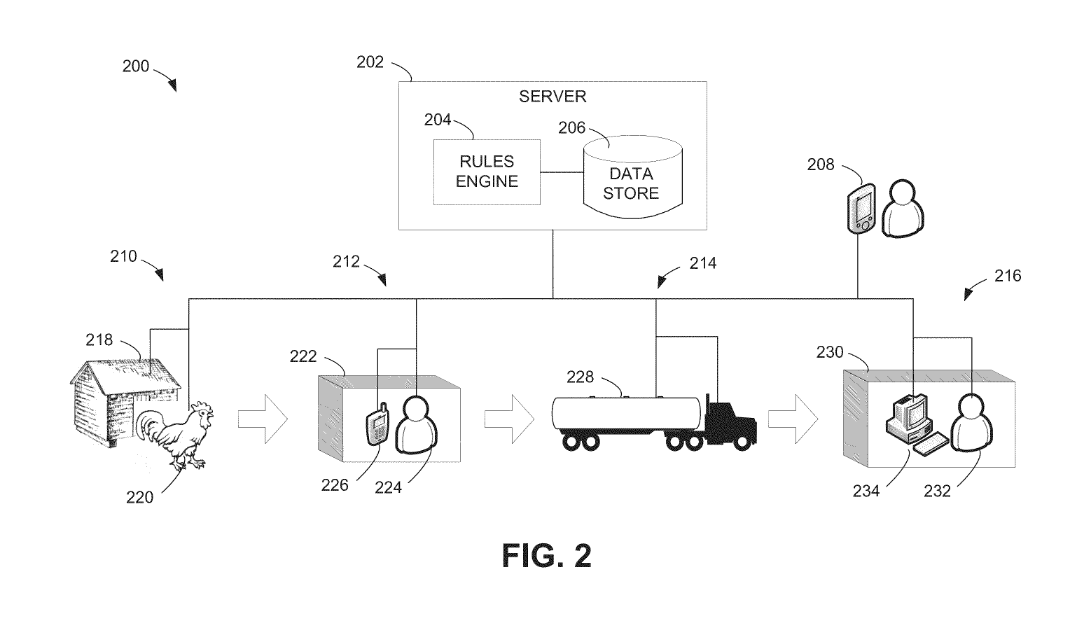

As one possible example of a distributed environment in which system 100 may be used, FIG. 2 illustrates a food supply cold chain monitoring system 200. Such a system 200 may be used in a food production and supply environment, in which food products must be maintained within a prescribed temperature range throughout the production and distribution process, from an originating farm to a consumer's table. In some embodiments, a centralized server 202 may monitor and analyze the end-to-end operations of a food supply chain. Though, it should be appreciated that embodiments are not limited to a single centralized server and may utilize multiple computing devices to monitor and analyze data. Regardless of the exact number and nature of computing devices that analyze and monitor data, a rules engine 204 and a data store 206 may be used to analyze and store various data collected throughout the food supply chain, and to monitor compliance with one or more standards related to a cold chain requirement.

The example of FIG. 2 illustrates a food supply chain in which a cold chain must be maintained by various entities involved in the food supply chain. The requirements of a cold chain may be set, for example, by a buyer of the foods or by any other suitable entity. As a non-limiting example, a cold chain for ice cream may require that a perishable product stay at a certain temperature, such as −0.5° Celsius, and that deviations from this temperature cannot exceed 16° for more than 15 minutes. To enable safe delivery of the perishable food product to a consumer, it may be required that different entities involved in the food supply chain comply with this cold chain requirement. Non-compliance and/or potential non-compliance with the cold chain may be reported by the server 202 to a reporting device 208, which may be operated by a worker and/or supervisor in the food supply chain. It should be appreciated, however, that a reporting device 208 is optional, and that results of the analysis by a server 202 may be reported to any suitable computing device within the food supply chain, including the sensors.

In the example of FIG. 2, four entities are illustrated that are involved in the food supply chain, and each of which is responsible for complying with the cold chain requirements. The entities illustrated are a food production entity 210, a food storage entity 212, a food transportation entity 214, and a food distribution entity 216. It should be appreciated, however, that embodiments are not limited to a particular number or nature of entities, and that any suitable number and type of entity may be monitored to collect data for analysis by the server 202. Furthermore, the number of entities from which data is collected may dynamically change with time, and the server 202 may be configured to dynamically update its analysis to accommodate such dynamically changing data.

In the example of FIG. 2, each of the four entities, 210, 212, 214, and 216, may be responsible for complying with the cold chain requirement. As a non-limiting example, FIG. 2 illustrates the production and transportation of eggs laid by hens. In such scenarios, there may exist a set of governmental regulations for maintaining the cold chain, such as a Food and Drug Administration (FDA) regulation that requires a cold chain of 7° Celsius to be maintained from collection through purchase of the eggs. This requirement may apply to an offline production unit, transportation systems, packaging, all the way through the point of purchase. It should be appreciated, however, that embodiments are not limited to monitoring and analyzing cold chain requirements and that any suitable metric within a food supply chain, or any other distributed environment, may be monitored and analyzed for compliance by the system 200. For example, in the context of egg production and distribution, the system 200 may monitor and analyze requirements for vaccination of hens, environmental conditions surrounding the eggs and/or hens, such as rodent infestation, or other suitable regulations and/or instructions that should be followed by the different entities in the food supply chain.

In some embodiments, the system 200 may be configured to monitor and analyze data at certain critical points in the cold chain. Such critical points may represent potential sources of failure or non-compliance in the cold chain. For example, critical points may be designated at outdoor loading docks, which may have prescribed time limits for unloading and loading the eggs, or may be designated at a holding facility, which may have requirements on refrigerating eggs at a certain temperature based on the age of the eggs, or may be designated at a transportation entity that may be required to maintain a prescribed temperature during transportation, and comply with maximum loading and unloading times during transfer of the eggs. Such regulations or instructions may be based on governmental rules and/or company specific protocols. Regardless of the nature of the standards and the critical points at which they apply, the server 202 may collect and analyze data from one or more critical points in the system 200. Such critical points may be located at entities in different industries, with different applicable standards and regulations. The server 202 may be able to analyze and correlate the different types of data and determine an overall strategy of operation to improve efficiency of the end-to-end supply chain.

In the example of FIG. 2, illustrating an egg supply chain, a farm 210 may have one or more sensors in a hen house 218, or any other suitable structure, such as a storage facility operated by the farm entity 210. In some embodiments, sensors in the hen house 218 may monitor and collect various types of data, such as ambient temperature, temperature inside certain machinery or facilities, or any other suitable type of data related to maintaining the cold chain requirements in the farm 210.

Additionally or alternatively, one or more sensors may be configured to detect data from hens 220, such as a body temperature of the hens or number of eggs laid by the hens. Such data may be used by the server 202 to cross-correlate with other types of data, for example, those collected by sensors in the hen house 218, to improve the accuracy and reliability of determining compliance with the cold chain in the farm 210.

Another entity that may be monitored is a storage entity 212, which may comprise a warehouse 222 that temporarily stores eggs produced by the farm 210. The storage entity 212 may be separate from or part of the farm 210. Regardless of the exact nature of the storage entity 212, one or more sensors may be placed at suitable locations in the storage entity 212 to monitor compliance of stored eggs with the cold chain requirement.

As non-limiting examples, sensors may be placed at positions in a warehouse 222 to measure ambient temperature or temperatures inside refrigeration units. Additionally or alternatively, sensors may be configured to detect behavior of workers, such as a worker 224. The monitored behavior of the worker 224 may include, for example, time spent on certain tasks, completion of tasks, and/or efficiency in completing tasks. Such human behavioral data may be correlated with other types of data collected within the warehouse 222 and analyzed in aggregate by the server 202 to determine an overall compliance with cold chain requirements by the storage entity 212.

In some embodiments, results of the analysis by server 202 may be displayed on a device 226, which may be a mobile device operated by the user 224. As non-limiting examples, the device 226 may present alerts regarding compliance or potential non-compliance, or may present instructions and/or recommendations to a worker 224 based on analyzed data. The instructions and/or recommendations may be based on a set of protocols established by the storage entity 212, and may relate to operation of machines, handling of eggs, recording or reporting certain actions, or any other task related to compliance with the cold chain by the storage entity 212. Additionally or alternatively, the mobile device 226 may be configured to detect data from the worker 224, using for example, microphones and/or other sensors.

In some embodiments, if the collected data indicates a behavior by the human worker 224 that is inconsistent with either data collected from other sensors, or is inconsistent with standards and regulations for compliance with the cold chain, an alert may be generated indicating potential error and/or fraud by the human worker 224. By detecting such non-compliance behavior by human workers, a potential source of problems may be detected before the problems manifest in the actual product. For example, if the collected data indicates that the human worker 224 spent more than a prescribed amount of time at an outdoor loading dock, either by motion sensors or cameras, then such data may indicate that the shipment of eggs handled by that worker may not be compliant with cold chain requirements at that critical point, even though records and/or logs kept by the worker 224 may indicate compliance.

In such scenarios, the rules engine 204 may recognize an inconsistency between the collected human data and other data, and may generate an alert indicating a potential source of non-compliance by the worker 224. Such an alert may be used, for example, by the storage entity 212 to check the shipment of eggs handled by the worker 224 to test for compliance with the cold chain, and/or the alert may be used by other entities, such as the shipping entity 214, to check that particular shipment of eggs before loading it onto their trucks. As such, human data may be used to detect potential sources of non-compliance, even when other sources of data, whether collected by sensors or entered by humans, do not indicate any problems. The rules engine 204 may also be configured to detect lack of collected data, whether due to malfunctioning sensors or due to human error and/or fraud, and to generate alerts based on the lack of collected data. In the example of FIG. 2, another entity that may be monitored is a shipping entity 214. A truck 228 of the shipping entity 214 may have one or more sensors to detect data related to compliance with the cold chain requirement or the shipping entity 214. As non-limiting examples, sensors may be configured to detect temperature inside of a holding tank of the truck 228, mileage and/or time of transport for the truck 228, location of the truck 228, or other suitable data related to transport of the eggs by the shipping entity 214. Sensors may also be configured to detect human behavioral data from a driver of the truck 228, such as whether the driver has performed required checks on the temperature in the holding tank of the truck 228, or other human tasks related to proper cold chain maintenance of the eggs. Regardless of the exact nature of the data collected by the sensors, such data may be analyzed by the rules engine 204, and one or more alerts and/or instructions may be generated and provided to the shipping entity 214 and/or other entities in the egg supply chain.

For example, if any of the collected data from the truck 228 indicates a break in the cold chain, then the server 202 may alert the receiving warehouse entity 216 that the upcoming shipment is non-compliant. Additionally or alternatively, a dispatcher, or other person responsible for the value of the good, may be notified. Such alerts and/or instructions may be generated in real time, so that any potential breaks of the cold chain by the shipping entity 214 may be detected and alerted to the appropriate parties in a real time and transparent manner. In some embodiments, this may enable proactive actions to be taken to maintain efficient operation of the supply chain despite the potential non-compliance, and also to enable proper accountability regarding the break in the cold chain.

In some embodiments, the system may automatically implement corrective actions using machine-to-machine interactions to resolve the non-compliance. In the example above, upon detecting a non-complaint loading of a shipment at warehouse 222 by worker 224, the system may automatically cancel the order for the shipment carried by truck 228 and re-order another shipment to replace the non-compliant shipment. As such, an entity scheduled to receive the non-compliant shipment, such as distribution facility 230, may receive alerts from the system about the non-compliant shipment from truck 228, before the truck even arrives, and may be instructed to wait for a replacement shipment. The intelligent system may thus enable more efficient operation of the distributed work environment by proactively mitigating potential sources of non-compliance, and re-configuring operations of the distributed work environment to resolve the non-compliance.

In some embodiments, one or more of the entities 210, 212, 214, and 216, may have its own internal cold chain logistics to monitor cold chain compliance within its own operations. For example, a transportation operator 214 may have monitoring devices, such as GPS trackers and temperature meters, installed on its trucks and data collected by such devices may be sent to a computer that is monitored by the transportation entity 214. However, such data may not be available on a real time basis to other entities in the food supply chain. For example, the distributor 216 may only notice a problem with a shipment of eggs after it has already been received and processed at the distribution center 230. A break in the cold chain may have occurred in the transportation entity 214, but may not have been caught or may have deliberately been ignored, resulting in the non-compliant shipment to the distributor 216. While it may be possible for the distributor 216 and the transporter 214 to reactively search through the collected data from the trucks, and determine where the cold chain was broken, this may result in delays and excess cost, and the records may not be reliable. By using an intelligent behavior management system, such as system 200, the distributor 216 may instead be able to track, in real time, compliance by the transport entity 214 with its cold chain requirements. In some embodiments, the distributor 216 may be able to recognize a problem before a truck even gets to the distribution center 230.

In some embodiments, the server 202 may be able to provide predictive analysis, to identify potential sources of non-compliance before they actually occur. In such scenarios, the transportation entity 214 and/or the distributor 216, or any other entity in the food supply chain, may take appropriate action to mitigate and resolve the potential source of non-compliance. For example, the distributor 216 may proactively request more eggs be delivered to replace a shipment that is potentially non-compliant, even before the shipment arrives. This may enable more streamlined and efficient operation by the distributor 216, and the food supply chain in general. Such end-to-end, integrated monitoring and analysis of the entire food supply chain may improve transparency and accountability of various entities involved in the food supply chain, and may proactively mitigate potential sources of errors and/or fraud. By monitoring both human data and machine data, the system 200 may not only transparently detect non-compliance, but may also be able to determine a reason for the non-compliance and make this data available to the affected parties.

In some embodiments, one or more sensors may also collect data from within the distribution facility 230, such as a worker 232, or one or more machines, such as a computing device 234. The collected data, which may comprise human data and machine data, may be analyzed by the rules engine 204 to determine compliance with the cold chain in the distribution facility 230. Such data may also be utilized to verify and validate data collected from other entities, such as shipping entity 214. As such, the integrated system 200 may be able to perform real time and proactive management of the supply chain by analyzing data from different companies across different industries which may otherwise be segregated into separate silos. Such an integrated system 200 may help improve overall efficiency by providing an integrated view of the distributed work environment, and in some embodiments, may enable a supervisor using a reporting device 208 to manage the entire end-to-end operations of the supply chain without necessarily relying on delayed feedback and reactive solutions to problems that have already occurred.

The integrated system 200 may enable not only faster response to problems that have already occurred, but may also enable proactive actions to mitigate potential problems that may occur in the future. In some embodiments, this may be achieved by cross-correlating data that has been collected from different entities, which may comprise both human data and machine data, and detecting any inconsistencies that may indicate non-compliance with a set of provided standards and/or instructions. Such a preventative system, may, in some embodiments, drastically improve the efficiency and productivity of a distributed work environment, and particularly those that involve multiple entities distributed over a wide geographic area, which otherwise may not communicate or coordinate with each other.

The system 200, in some embodiments, may also have the ability to adaptively learn and predict the behavior and actions of workers and/or entities in the distributed work environment to facilitate proactive alerts. Such learning and predictive analysis may be enabled, in some embodiments, by any suitable learning technique, such as machine learning algorithms, neural networks, simulations, or other suitable techniques, as embodiments are not limited in this regard. Regardless of the exact nature of the analysis implemented by the rules engine 204, the analysis may be configured to operate on a wide variety of data collected by different sensors, and in some embodiments, stored in the data store 206. The data store 206 may comprise data that is collected from sensors, and also may comprise standards, regulations, and specifications that should be followed by one or more entities and the distributed work environment.

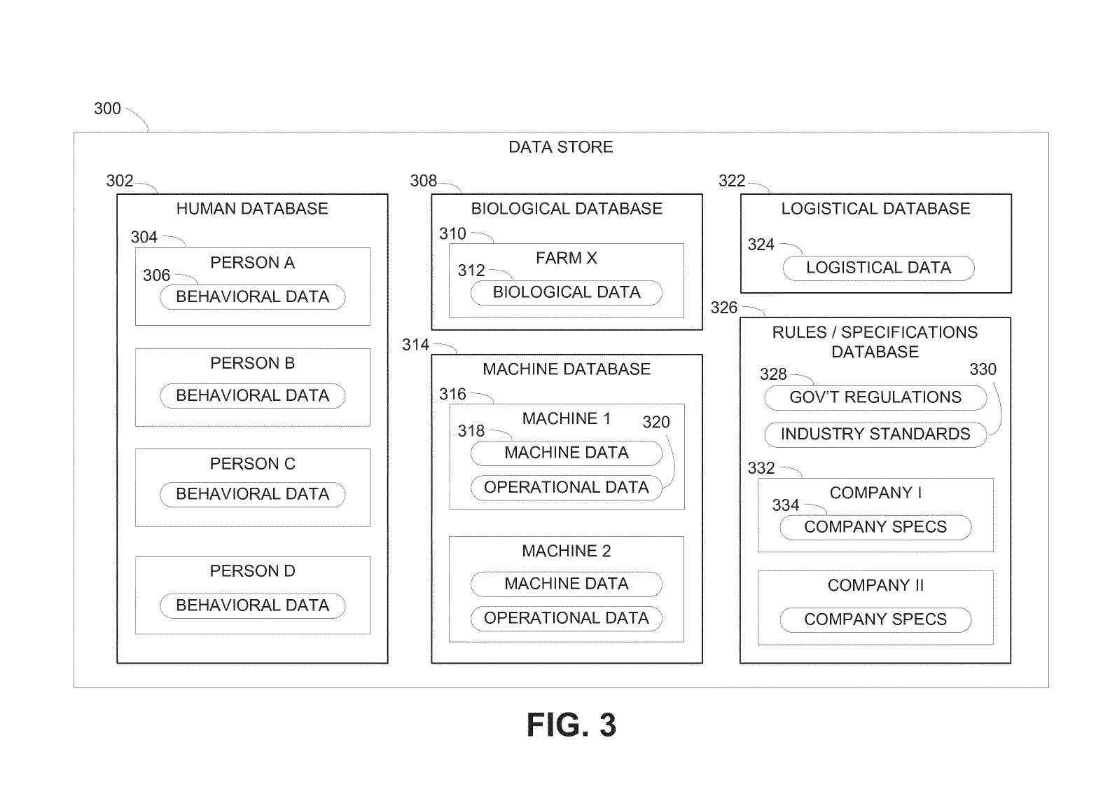

FIG. 3 illustrates one example of a data store 300 that stores various types of data and standards. It should be appreciated, however, that embodiments are not limited to storing these particular types of data, as more or less types of data and standards may be stored suitable to the environment in which the system operates.

Although embodiments are not limited to the exact nature of data stored in the data store 300, in some embodiments, the data store 300 may store at least eight types of data and standards, as described in the foregoing. The inventors have recognized and appreciated that analyzing at least these eight different types of data and standards may improve distributed work management by providing an integrated and holistic view of the workflow environment. In some embodiments, the data store 300 may comprise: behavioral data, operational data, biological and environmental data, machine data, logistical data, regulatory rules, industry standards, and company specifications. It should be appreciated, however, that more or less types of data may be stored in the data store 300 and analyzed by a rules engine (e.g. rules engine 204 in FIG. 2), as embodiments are not limited in this regard.

In some embodiments, the human database 302 may comprises data representing behavior and actions of workers. Human database 302 may include one or more entries for human workers, four of which are shown in FIG. 3, as person A, person B, person C, and person D. It should be appreciated, however, that embodiments are not limited to any particular number of humans for which data is stored. In some embodiments, data stored for a person may include behavioral data representing one or more behaviors or actions taken by the person. In FIG. 3, person A's data 304 is shown with behavioral data 306. As non-limiting examples of behavioral data 306 that may be stored in the human database 302, data collected by cameras, motion sensors, microphones, GPS systems, accelerometers, infrared systems, or other types of sensors may be stored, related to specific tasks or actions for which the worker has been responsible.

In some embodiments, the data store 300 may store a biological and environmental database 308 that stores data collected from one or more biological and/or environmental sensors, representing information related to various organisms and/or environments. As a non-limiting example, in the scenario of an egg production and distribution chain, the biological database 308 may contain data related to hens that produce the eggs in a farm. For example, the biological database 308 may contain farm data 310 for a farm X, which may contain biological data 312 related to hens and/or other animals in the farm. The biological data 312 may be collected by sensors that are either attached to the hens or remote from the hens, and may indicate a general health status of the hens relevant to production and quality of eggs.

In some embodiments, the data store 300 may comprise a machine database 314 that stores data related to one or more machines in the distributed work environment. In the example of FIG. 3, data for two machines is shown, though embodiments are not limited to a particular number of machines. In some embodiments, machine 1 data 316 may comprise machine data 318 that relates to specific measurements and/or outputs related to machine 1. Such data may be collected by sensors that detect various metrics associated with machine 1, such as temperature and/or production. The machine 1 data 316 may also comprise, in some embodiments, operational data 320, which may represent protocols and/or procedures to be followed when operating machine 1. In some embodiments, operational data 320 may be used by a rules engine (e.g. rules engine 204 in FIG. 2) to detect non-compliance and/or provide instructions to workers based on analyzed data related to machine 1. Though, it should be appreciated that other types of operational data may be stored in data store 300, representing operating steps and/or protocols to be followed in performing certain actions, not necessarily related to machines.

In some embodiments, data store 300 may comprise a logistical database 322 that stores logistical data 324, which may represent information related to the logistical operations of the work environment, such as distribution and supply chain logistics. As non-limiting examples, the logistical data 324 may include information related to transportation, distribution, and/or transfer of goods between different entities. It should be appreciated, however, that logistical data 324 is not limited to a supply chain environment, and may represent logistical data from any suitable work environment. Such logistical data may be used, for example, by a rules engine (e.g. rules engine 204 in FIG. 2) to determine logistical compliance and/or to provide instructions for logistical operations.

In some embodiments, the data store 300 may comprise a rules/instructions database 326, which may store data related to various standards, such as regulations, rules, and/or specifications applicable to the distributed work environment. As non-limiting examples, the rules database 326 may comprise governmental regulations 328, which may be related to the particular industries involved in the distributed work environment, and industry standards 330, which may represent protocols and/or standards established by, for example, industry organizations or trade groups.

In some embodiments, the rules database 326 may comprise company specifications, which may represent company specific protocols and/or rules established by specific companies participating in the distributed work environment. For example, two companies are illustrated in FIG. 3, though embodiments are not limited to a particular number of companies. As a non-limiting example, company 1 data 332 may comprise company specifications 334, which may represent procedures and/or protocols to be followed by workers in company 1. In some embodiments, the company specifications 334 may be internally established by the company, and may be based on the governmental regulations 328 and/or the industry standards 330.

It should be appreciated, however, that the rules database 326 is not limited to these specific types of standards, and that more or less standards may be stored in the data store 300. For example, in some embodiments, there may be no applicable governmental regulations 328 and/or no applicable industry standards 330, in which case the rules database 326 may only comprise company specifications, such as for company 1 data 332.

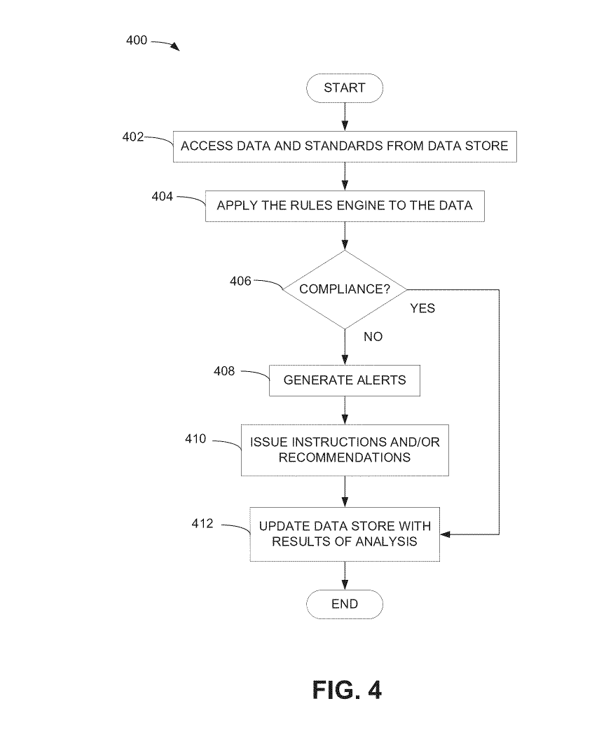

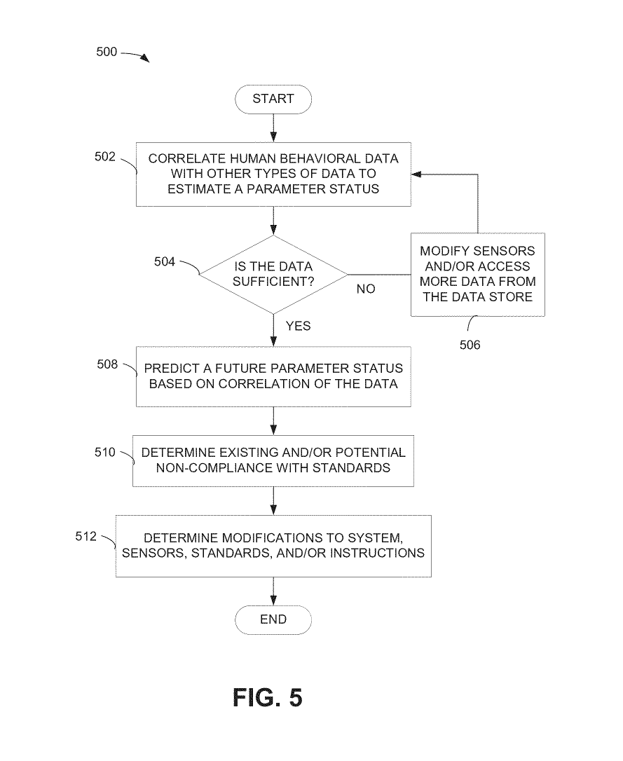

FIGS. 4 and 5 are flow charts that describe examples of processing that may be performed by a server (e.g., server 202 in FIG. 2), or any other computing device that analyzes data collected from sensors. The various steps involved in FIGS. 4 and 5 may be performed in real time as data is collected and received from the sensors, or may be performed in an offline manner with data already available for analysis. Regardless of the exact times and manner in which the steps of FIGS. 4 and 5 are implemented, the processes described in these examples may be used to analyze and aggregate data collected from sensors, estimate a parameter status of the underlying system, including machines and humans, predict a future parameter status of the system, detect non-compliance or potential non-compliance, and/or generate alerts instructions based on the analysis.

FIG. 4 is a flowchart of an example of a process 400 that may be implemented by a server (e.g., server 202 in FIG. 2, or server 102 in FIG. 1). Process 400 may begin in block 402 with the server accessing data and/or standards from a data store (e.g., data store 300 in FIG. 3). Though, it should be appreciated that data and/or standards may be accessed from any suitable data store, which may be local to the server or at a remote location, for example, connected to a network accessible by the server. In some embodiments, the data and/or standards that are accessed in block 402 may be a subset of the data and standards stored in a data store. In scenarios in which there is a large amount of collected data and/or standards, such selective accessing of information from the data store may enable more efficient and faster analysis. For example, different types of data may contribute different amounts of utility to an analysis of compliance with one or more standards. The rules engine may be able to determine, based on prior measurements and analysis, which types of data yields the highest expected information gain, and may access only those data.

In some embodiments, sensors may be configured to collect or not collect certain types of data. For example, some sensors may be configured not to collect data in order to conserve energy and/or communication resources, based on a determination that data collected by those sensors would yield smaller expected information gain than other sensors. Regardless of the exact nature in which data is accessed and/or available, the system may recognize that only a subset of data that could potentially be collected by the sensors may be sufficient to yield a desired level of estimation and/or prediction accuracy, and that data collected by other sensors may yield diminishing returns.

Based on the data and standards that have been accessed from the data store, in block 404, the rules engine may be applied to the collected data and prescribed standards, to determine compliance and/or future compliance throughout the distributed work environment. In block 406, if it is determined that the analyzed data indicates non-compliance or potential future non-compliance, then, in block 408, the system may generate one or more alerts to an appropriate entity, such as a supervisor or a worker. Additionally, or alternatively, the system may, in block 410, issue one or more remediation instructions based on the analysis of the collected data. In some embodiments, the remediation instructions may be related to adjusting or modifying human tasks and/or machine operations, to better comply with the standards, though embodiments are not limited in this regard.

In some embodiments, in addition or as an alternative to generating alerts/instructions, the system may implement other types of corrective actions, such as automatically implementing one or more of the recommendations/instructions, or implementing other changes to operations of the distributed work environment, using machine-to-machine interactions. For example, in some embodiments, after generating an alert based on a detected non-compliance, if the system detects no response to the alert, then an elevated alert may be generated to a supervisor and/or a customer and/or other suitable entity. If still no response is received for the elevated alert(s), then the system may use machine-to-machine interactions to automatically implement changes to the operations of the distributed work environment to resolve the compliance, without human intervention.

The system may also use data based on historical information, related to one or more workers involved in the workflow chain. For example, the system may analyze past performance of a hospital intern in administering a particular type of drug, and may issue recommendations to assign or to not assign that task to that particular intern, and/or the system may automatically update a database to re-assign the task to another entity. As another example, in the context of a rescue operation, based on a measured health condition of a rescue worker, the system may issue recommendations for that particular rescue worker to not participate in a particular rescue operation and/or the system may automatically restrict or disable that worker's access to participate in the particular operation. For example, the biological condition of the worker may be based on historical medical analysis of the rescue worker. As another non-limiting example in the context of airline pre-flight checks, if a particular member of a ground crew has a history of not completing a certain task on time, then the system may adaptively learn to collect more detailed data from that particular worker performing that particular task, to more accurately and reliably detect potential non-compliance at a critical control point. Additionally or alternatively, the system may recommend that that particular ground crew member not be assigned to that particular task, and/or may automatically update the work logs to re-assign the task to another worker and disable authorization of liftoff for the plane until the task has been properly completed.

Regardless of the exact nature of human data that is collected and analyzed, various types of sensors may be used to analyze, learn, and predict the behavior of humans performing certain tasks at critical control points of the distributed workflow chain, and may issue alerts and/or remediation instructions based on the analysis to a supervisor or other suitable entity in recognition of potential non-compliance that may occur. Such a system may provide a supervisor or other suitable entity with an intelligent behavior management system that proactively detects and/or prevents human error and/or intentional fraud.

It should be appreciated that embodiments are not limited to the foregoing examples, as an intelligent behavior management system may be used in any suitable distributed work environment. Regardless of the exact nature and context of the workflow environment, the rules engine may analyze collected data and pre-specified standards at different critical control points in the workflow environment, to detect compliance and/or potential future non-compliance, and issue remediation instructions and/or alerts regarding certain actions that should or should not be taken at those critical control points.

After appropriate remediation instructions have been issued in block 410, in some embodiments, the data store may be updated with results of the analysis and/or the issued instructions. For example, human data for a worker may be updated with non-compliance or potential future non-compliance detected for that particular worker. The data store may also be updated with revised standards and/or instructions based on results of analyzed data. In some embodiments, if the rules engine has detected full compliance based on the collected data, then the updating of the data store in block 412 may be performed after compliance detection in block 406, without generating any alerts and/or instructions. It should be appreciated that issuing remediation instructions in block 410 and/or updating the data store in block 412 are optional, and in some embodiments, an alert may be generated without any remediation instructions or updates of the data store.

FIG. 5 is a flowchart of an exemplary process 500 of processing by a rules engine. For example, process 500 may represent more details of the processing performed by the rules engine (e.g. block 404 of FIG. 4) to analyze the collected data. The process 500 performed by a rules engine may apply any combination of suitable techniques to analyze the different types of data collected by sensors, to detect compliance and/or potential non-compliance, identify sources of the non-compliance, and/or determine the appropriate instructions based on the analysis. Although process 500 in FIG. 5 illustrates one possible sequence of processing that may be performed by the rules engine, it should be appreciated that embodiments are not limited to any particular sequence or nature of processing and, in general, the rules engine may apply any suitable processing to the collected data to determine non-compliance and/or potential future non-compliance.

In block 502, the rules engine may correlate the various types of collected data, which, in some embodiments, may comprise human behavioral data, and the eight types of data described above and depicted in FIG. 3. Though, it should be appreciated that in some embodiments, more or less data may be used. For example, in some embodiments, the rules engine may only analyze human behavioral data. In some embodiments, if the data was compressed by the sensors prior to communication, then in step 502, the received data may be decompressed before performing correlation. Additionally or alternatively, decompression of any compressed data may be performed in block 402 of FIG. 4.

In some embodiments, some of the data that is correlated in block 502 may be related to a common parameter. For example, the data may be related to performing a particular operation or a operating on a particular machine in the distributed workflow chain. For example, in the context of airline preflight safety checks, the common parameter may be the safety of the airplane. In some embodiments, the parameter may not be directly measurable, in which case sensor data may be used to estimate the parameter. In such scenarios, correlation of the data may comprise performing data fusion and/or data mining to estimate a parameter status. For example, in some embodiments, data fusion may comprise processing the data collected by the sensors to create a more compact representation of information relevant to determining non-compliance in the system.

As a non-limiting example, parameter estimation may be performed by a Kalman filter. The Kalman filter may be used to transform a plurality of data collected by sensors into a more compact representation of the system, for example, by estimating an underling parameter status. In some embodiments, the Kalman filter may use a model of the dynamic behavior of an underlying parameter of the system. The parameter may be any suitable parameter chosen to represent a feature of operation. The particular model of dynamic behavior of the parameter may, in some embodiments, be provided as an offline input to the system, or may be learned in an online manner by the system, based on collected data and analysis results.

For example, in the context of the food supply cold chain, an underlying parameter of the system may be the actual temperature of the food. This parameter may not always be directly observable, due to sheer volume of food deliveries and/or lack of suitable food temperature monitoring at certain critical points in the supply chain. A model of food temperature dynamics may be provided to the rules engine, based on known biological properties of the food, spoilage rates, etc. In such scenarios, sensors may be used to collect sensed data such as ambient temperature on an outdoor loading dock, storage temperature of a truck from which the food was unloaded, a duration of time during which the food was kept on the loading dock, and a previously measured temperature of the food at a prior step in the food supply chain. The sensed data may be input into a Kalman filter, which may apply the dynamic model of food temperature, and collected data from sensors, in order to estimate a current temperature of the food that is sitting on the loading dock.

In some embodiments, block 502 may, additionally or alternatively, apply data mining algorithms, which may comprise detecting any anomalies, patterns, classifications, and/or other associations between the different types of data collected. In some embodiments, if the collected data is voluminous, then the data fusion and/or data mining algorithm may enable representing the voluminous data in a more compact manner. Though, it should be appreciated that block 502 is not necessarily limited to generating compact representations of the collected data, as correlation of data may comprise any suitable processing to determine correlations between the data collected by the different types of sensors and to estimate an underlying parameter status of the system.

If the data that is correlated in block 502 is insufficient to determine an estimated parameter status of the system, then in block 504, it may be determined that more data is necessary. Then, in block 506, more data may be obtained, either from the data store or from the sensors, and the updated data may be used to perform the correlation in block 502. In some embodiments, the updated data in block 506 may simply be accessed by querying the data store for the desired data, and in some embodiments, a communication may be sent to one or more sensors to collect and transmit more or different types of data. Regardless of how this updated data is obtained, the processing in blocks 502, 504, and 506 may be repeated until it is determined that a sufficient amount of data is available.

Then in block 508, in some embodiments, the rules engine may generate a prediction of a future parameter status of the system, based on the measured data and the estimate of the current parameter status of the system determined in block 502. The prediction of a future parameter status may be achieved by any suitable machine learning algorithm. As non-limiting examples, machine learning algorithms may comprise neural networks, linear/non-linear optimizations, Bayesian learning networks, or other suitable techniques that can analyze data measured from a system to predict a future parameter status of the system.

For example, if a Kalman filter is again used, then the predictive step of the Kalman filtering processing may be used to generate a prediction of a future parameter status of the system, based on an estimated current parameter status and measurements from the sensors. For example, in the context of a food supply chain in some embodiments, the parameter status may be a temperature of a food. A Kalman filter may be able to generate a future prediction of the food temperature based on past measurements and a current estimate. As such, even if an actual measurement of the food temperature is not taken until later in the food supply chain, the rules engine may be able to proactively determine whether the food temperature is non-compliant, or may potentially become non-compliant, before actual food temperature measurements are taken.

Regardless of the exact nature of prediction performed in block 508, any suitable machine learning algorithm may be used, whether supervised with actual measurements of the parameter status, or unsupervised with only data collected from sensors external to the parameter status, to estimate predictions of a future parameter status of the system. Such predictions may be used, for example, to determine potential non-compliance in the future, which may enable a proactive protocol in which potential problems are mitigated before they propagate to other parts of the distributed work chain.

In block 510, the estimates of the current parameter status generated in block 502 and/or the predictions of a future parameter status generated in block 508 may be correlated with prescribed standards and/or regulations to determine existing non-compliance and/or potential future non-compliance. For example, in the context of the food supply chain, a loading dock that holds a shipment of food which has been determined by the rules engine to potentially become non-compliant in a subsequent step of the supply chain may be proactively flagged and appropriate workers and/or supervisors may be alerted that the particular food shipment must be checked before it proceeds to subsequent storage and distribution. The standards (e.g., from 326 in FIG. 3) applied in block 510 may be any suitable set of standards provided by governmental agencies, industry trade groups, or within a specific company.

In some embodiments, based on the analysis of the data collected by the sensors, in block 512, the rules engine may determine appropriate modifications to the distributed work environment. For example, such modifications may comprise reassigning workers to different tasks, adjusting different settings on machines, and/or modifying protocols of operation and/or logistics. In some embodiments, such modifications may be performed in response to a detected non-compliance and/or potential future non-compliance, or may be performed even when no non-compliance is detected.

In some embodiments, block 512 may additionally or alternatively comprise modifying or reconfiguring sensors, to collect more, less, or different types of data. For example, the rules engine may determine, based on the results of the analysis, which collected data are most useful in determining non-compliance at one or more critical control points, or at any other part of the workflow chain. Based on such determination, the system may reconfigure the sensors such that only those sensors whose measurements yields the highest expected information gain perform data measurement and communication. In some embodiments, this may enable improved usage of resource constrained sensors, and/or may streamline the processing by the rules engine by correlating only the data that is most useful in block 502. In addition, or as an alternative, to resource management, sensor reconfiguration may be performed to improve the accuracy and reliability of estimation and/or prediction of non-compliance. Such sensory configuration may comprise collecting more data, or different types of data at certain critical control points, or other parts of the workflow chain.

While FIG. 5 has been described using examples from the context of a food supply chain, it should be appreciated that a rules engine performing estimation and prediction of non-compliance based on human behavioral data and other data may be applied to different types of distributed work environments. For example, in the context of airline pre-flight safety checks, the rules engine may analyze data collected from tasks that should be performed by a pilot, ground crew, and a tower, to estimate an underlying state of safety for the airplane, and/or predict a future state of safety for the airplane. For example, if an ambient temperature sensor detects potential frost conditions, and a human behavioral sensor detects that a member of the ground crew has not spent an adequate amount of time checking a certain location of an airplane's wings, and a machine data sensor detects that a particular aileron is slow to respond to a pilot's controls, and a database indicates that the particular aileron has traveled beyond its mileage limit, then the rules engine may correlate all this data to either estimate that a current state of the airplane is non-compliant with safety rules, or may predict that a future safety state of the airplane will soon become non-compliant. The system may then generate an alert or recommendations to the pilot, ground crew, and/or the tower, to either prevent liftoff of the airplane, or to take additional preventative measures before takeoff.

By combining human behavioral data with other types of data that may be collected by sensors, the rules engine may be able to determine not only that equipment or other supplies are potentially non-compliant, but also that human workers responsible for checking compliance or helping to ensure compliance, have not adequately done so. The human behavioral data, in some embodiments, may add additional dimensions of information that may not otherwise be available in data collected by machine data sensors, biological data sensors, or other types of sensors alone. In distributed work environments where humans are an integral part of the work, human behavioral data may provide a valuable source of information to more accurately estimate and predict an underlying state of the system, and may provide more accurate guidance on managing and delegating tasks to human workers, to improve overall compliance of operations throughout the end-to-end workflow chain.

The following describes some examples of various embodiments of an intelligent behavior management system. In this example, a high-level architecture for a Compliance Management System that is applicable to Food Safety and other domains is presented. It should be appreciated, however, that this is merely one non-limiting example, and embodiments are not necessarily limited to the exact techniques and architecture presented in this example.

In some embodiments, a Compliance Management System (“CMS”) may determine, based on observations, whether operations conform to policies across a wide variety of domains. The CMS is a general-purpose tool potentially applicable to any domain that uses observations to determine compliance with policies. It is intended to be “general purpose” in the same sense that “rule engines” and “task management systems” are general-purpose business tools useful across many domains and applications.

A secondary goal of CMS is to accumulate the observational data gathered and employ analytics and data mining techniques to derive additional benefit from them—for example, to optimize or monitor the health of business processes. With the right algorithms, this observational data can also be potentially used to determine the “best vendor” in a supply chain, and to mine observations for indications that hidden compliance violations may be occurring or about to occur. Because of the expected volume of these observations, a scalable “BigData” analytics approach is proposed.

While many of the examples used in this document are taken from the food safety domain, this should not be construed to be the purpose of the CMS. These examples are used because this may be one early application of the system and because this domain is familiar to the initial audience for this document. The CMS itself is intended as a general-purpose platform applicable to many domains.

The purpose of this High-Level Architecture document is to capture the major aspects of the Compliance Management domain, according to some embodiments, and translate them into technical terms. The intent is to concretely lay out the major technology decisions, and provide the overall architectural framework within which detailed component-level design can proceed in a coordinated manner in parallel with system implementation. It is not envisioned that every detail of the system will be specified to the point where implementation can proceed in a mechanical manner without further technical design work; rather it is to provide the overview and framework within which further refinement can be made.

1. Objective

In some embodiments, compliance standards or, more generally, “policies” may be set by an external entity, which may include government bodies; purchasers, distributors and retailers of regulated services or commodities; manufacturers or producers of the regulated items; and corporate entities which own such producers. Various means of monitoring compliance data are provided by the system, including interfaces for external electronic sensors, data from third-party systems, and manual data gathered by workers executing assigned tasks. As the compliance data is received, it is evaluated by the system against the policies applicable to it.

In some embodiments, when a compliance violation is detected, the compliance violation handler is invoked for the specific rule or rules being violated. This handler may, for example, send an alert to all entities with permission to receive such alerts. Permissions are set by the business entities (e.g. an individual Farm or manufacturing facility) who specify which compliance rules are applicable to the goods or services they produce, and which entities are to be notified when those rules are violated. Entities receiving compliance alerts also may view the real-time compliance status of all producers who have given them permission to do so.

In some non-limiting embodiments, compliance status is tracked by time and for a given touch-point; for example, “At 11:42 am EST 11 Nov. 2012, Farm #1234 was compliant with respect to the Walmart Best in Class Shell Egg ruleset.” In some embodiments, a Touchpoint may be mobile—for example, a refrigerated truck transporting perishable goods. The distinguishing characteristic of a Touchpoint is that it has a unique time-invariant identity, and that compliance rules may be applied to it.

Compliance status may not necessarily be tied to the items being produced; instead compliance may be a process metric tied to a particular location and time. For example, a particular egg is not in itself determined by the system to be compliant or non-compliant. Rather compliance status as measured by this system relates to the producer location and time. In some embodiments, items or activities that are produced at a location that are currently in compliance may be deemed “compliant”—but it is the location that is actually being measured by the system.

2. Concept Overview

The terminology used here is intended to be neutral across industry domains, and to define a platform that can be easily deployed across multiple industry-specific domains.

2.1 Key Concepts

2.1.1 Domain

“Domain” refers to a specific Business Vertical that the Compliance Management System may be configured to manage. The CMS System is designed as a general-purpose policy compliance engine within which different Business Vertical solutions can be configured. The term ‘Domain’ refers to one such Business Vertical, and various Configuration and Customized applications associated with it.

Examples of potential domains include, for example, ‘Egg Safety’ and ‘Software Services’. Some of the Usage Scenarios related to these industries are described further under section ‘3. Solution Overview.’

Also, section ‘2.5 Setup a Domain’ describes further these concepts, and how a new Domain may be configured in some embodiments.

2.1.2 Business Entity

“Business Entity” refers to a Company that registers in the System and receives access to the Services of the CMS system. In some embodiments, the CMS system may provide a self-service provisioning process that allows Business Entities of specific types to register and specify their operational configuration (see below) within the System.

From an architectural perspective, a Business Entity may be a set of “Touchpoints” (defined below) connected by a directed graph. This will be explained in more detail later.

In some embodiments, Business Entities may have “customers”—the people they furnish items to—and suppliers, the people they buy things from. Architecturally these are represented as Touchpoints outside of the business entity. As part of the setup process the business entity may identify its suppliers and customers so that it can subscribe to their compliance status. The Business entity may also subscribe to one or more Policies against which to measure their own compliance as well as, provision Users and setup Task Libraries.

In some embodiments, the relationships between the Touchpoints owned by the various Business Entities represent the complex supply chain structures that may be tracked and monitored by the system.

Examples of Business Entities for the ‘Chicken Shell Egg’ domain may include Retailers (E.g. Walmart, Kroger and Safeway), Distribution Companies, Farm Houses, Hatcheries etc.

For the ‘Software Compliance’ domain, Business Entities may include Independent Software Vendors, Design Firms, Tool Vendors, Hosting and Cloud Service Providers, just to name a few non-limiting examples.

2.1.3 Items

‘Items’ are the specific entities that are the subject of a policy or set of policies. Examples of Items may include, but are not limited to: “Chicken Shell Eggs” in the Food Safety domain; “Backlog Items/Defects” in the software development domain; “Aircraft Flights” in the aviation domain. Note that while the Items themselves may be the subject of compliance and other policies, in some embodiments, it is not the compliance of the Items that is tracked by this system. Rather it is the compliance of the Touchpoints where Items are produced or through which the Items pass that may be managed by the CMS.

An output of the system (from a compliance perspective) may include a declaration that at a given point in time the observations reported (or lack of observations) against a given Touchpoint indicated compliance or non-compliance of that Touchpoint with a set of policies. External systems may use this information to label the specific items being produced at that time as originating from a then-compliant Touchpoint—but in some embodiments, the CMS system itself may determine the compliance of the Touchpoint, not the Item.

2.1.4 Policy

‘Policies’ are a named set of guidelines (rules) whose intent is to ensure the safety, quality or some other aspect of Items. Policies may be legal requirements, vendor requirements, or a company or industry-specific set of conventions. Policies may or may not have force of law. “21 C.F.R. Part 118” is an FDA policy that governs the production, storage and transportation of shell eggs. For example, meeting the “Scrum ‘DONE’ criteria” is a policy that governs software defects and backlog item completion that has been adopted by many companies; and so on. One aspect of the CMS system is to determine, on the basis of observations, whether or not a given Policy is being complied with.

Rules and RuleSets

‘Rules’ are logical, conditional checks carried out against observations taken with respect to a given Touchpoint. In some embodiments, by checking these observations against a set of criteria, the rule evaluates the adherence of the Touchpoint to a specific Policy. The absence of a given observation may also be the subject of a rule. Rules may further be grouped into ‘RuleSets’ for easier management, and to associate the Rules to Touchpoints. RuleSets may not necessarily have architectural significance within the CMS, but may be a useful notion from a rule management conceptual perspective—and perhaps user experience point of view.

In some embodiments, a Rule may have access to the Observations captured against a Touchpoint, and information associated with those Observations. In particular, a rule may have access to various Touchpoint attributes, such as dynamic and historical Observation information and information about the Sensors (such as the sensor's location or the actor (user) who gathered the data, and so on) that gathered the information. In some embodiments, based upon this information, a Rule may define conditional blocks that yield a result.

As a non-limiting example, for the Egg Industry, a Rule may be specified against a Hen House (Touchpoint) that is related to the Weight of Chickens (Observation), using information about the Flock's Age (Touchpoint Attributes) and making the necessary judgments on whether the hens are within healthy limits for their age as specified under a particular Policy.

In some embodiments, rules may also apply to an entire graph or supply chain (see below). For example, there may be a policy that says that all eggs need to be washed. A rule could be created which specifies that a Touchpoint of type “washing station” must be in the portion of the supply chain graph that is upstream to a given retailer.

2.1.5 Compliance

“Compliance” is a declaration that based on Observations a particular Touchpoint conforms to a particular policy at a specific point in time. In some embodiments, the Compliance of a given Touchpoint may only be in terms of the subset of the policy that is applicable to it, based on the type of Touchpoint in question. Compliance may include, either explicitly or implicitly, accepting transfers only from other Compliant Touchpoints, or from a Supply chain (entire upstream portion of directed graph) that meets certain requirements.

2.1.6 Touchpoints

“Touchpoints” are the physical places or logical stages or steps through which an Item passes during the portions of its lifecycle that are governed by a Policy. In some embodiments, the Touchpoints may be “connected” in the sense that movement of Items through the Touchpoints follows the lines of a directed graph (explained further below). The graph “upstream” of a given node may model the supply chain to that node.

For example, in the Egg Safety domain, a “Farm” may be represented by a collection of Hen Houses, Feed Bins, and Conveyor Belts that are connected so that feed, supplies and chicken eggs flow through them in a specific configuration.

In the Software domain, a Touchpoint may be a logical phase gate or milestone in a project—for example, “Sprint is done” in Scrum.

A “graph” is a set of lines that connect nodes—for example, the nodes may be the Touchpoints, and the lines may indicate the physical or logical movement of Items between those nodes. Nodes (Touchpoints) may be physical locations (e.g. a henhouse or a feed storage location) or time-ordered events (for example, phase gates in software development process). A “directed graph” means that for each line, there is an associated direction. In the case of the CMS there may only be a single direction associated with each line—that is, the movement of Items between two Touchpoints flows in one direction only, never the reverse. The proposed architecture may tolerate loops between three or more Touchpoints under certain conditions, but it may take further evaluation of the domain to see if support for loops is really required. In some embodiments, support for cycles (loops) in the directed graph may not be required, if issues like “returns” may potentially be handled by using finer grained Touchpoints.

A graph may not necessarily restrict the arrangement of the nodes—a single node may be connected to multiple “downstream” nodes, meaning that for a given source there may be multiple destinations. The opposite may also happen, where multiple sources feed into a single destination.

In some embodiments, Compliance may be a state that applies only to Touchpoints, not to Items. Compliance may be a Touchpoint-specific process metric. If the “rules” for compliance are satisfied within a given Touchpoint, that Touchpoint may be deemed to be Compliant regardless of the state of the Items it contains. For example, a company, which adheres to the ISO9001 quality standard, may be (correctly) deemed to comply with that standard even though it produces low-quality products. This is because ISO9001 is a process-based standard, not a results-based standard.

2.1.7 Sensors and Observations

“Sensors” are the means for capturing and/or communicating Observations (or Facts) in the system. In some embodiments, the Observations captured may be the outcome of Tasks, readings from Equipment, or Data-Feeds from External Systems. The Observations captured via the Sensor may be with reference to a specific Touchpoint.

For example, in the Egg Safety domain, a Farm Worker may perform a designated Task to capture the temperature reading in Hen House using his mobile device Application. In this example, the Farm Worker (Actor) uses the mobile device (i.e. the Sensor) to capture the Temperature Reading (i.e. Observation) for a Hen House (Touchpoint). In the case of a network-enabled digital thermometer, the thermometer itself is the Sensor.

In some embodiments, the Observations collected via the Sensor are available as inputs into the Rule Engine, and may be used to test the compliance of a Touchpoint to a Policy.

2.1.8 Workflow and Tasks

“Workflow” refers to a set of human executable Tasks on the system. In some embodiments, a Task may be a single unit of work performed by a worker, and a Workflow may be composed of one or more Tasks performed sequentially. It should be appreciated, however, that embodiments are not necessarily limited to any particular structure or relationships between tasks and workflow.

In some embodiments, a Workflow may be provisioned on the system by an Administrator or Manager and assigned to one or a Group of Workers. The Worker can then update the status of the Task and upload Data relevant to the Task.

In some embodiments, Workflow templates or a Workflow library may be used to store and reuse frequently executed Tasks.

2.1.9 Users and Groups

A User refers to an Actor in the system. In some embodiments, Users may be provisioned in the system under the Business Entity they belong to, though this is not a requirement for all embodiments. A User may perform tasks for multiple business entities—for example, an exterminator may do work for multiple Farms—but that user may “belong” to a single business entity—in this case, perhaps an extermination company or sole proprietorship. In some embodiments, where a particular human being works for two different business entities—for example, having part-time jobs at multiple businesses—he or she may have a distinct identity in each case. A Group refers to a set of Users who share a common Role. A User can belong to one or more Groups and a Group can have one or more Users.

2.1.10 Role and Permissions

A Role refers to a User's profile on the system based on the actions he or she is allowed to perform. In some embodiments, Roles may allow access control Permissions to be set up for Users and Groups.

For example, a User with Role of Manager may be allowed to assign and monitor the Tasks performed by Users with Role of Worker.

2.1.11 Alerts

In some embodiments, Alerts may be sent when the status of a Touchpoint changes, though in general Alerts may be sent for any suitable reason, not necessarily limited to changes in Touchpoint status. The change could be, for example, from Compliance to Non-Compliance or from Non-Compliance to Compliance. In general, the System may support different types of alerts handlers; some examples include, but are not limited to: a push notification for the mobile device application, SMS, E-Mail, and Provision for Custom Notification Handlers.

2.2 Mapping to Industries

In some embodiments, the Concepts introduced in this section may form the basis of the Compliance Platform. Hence, the Terminologies used may be neutral to business verticals. In some embodiments, the Concepts introduced here may be mapped to multiple Industry verticals to build a customized solution.

Table 1 gives some examples of how these concepts may map to Industry Verticals.

TABLE 1

| Domain Concepts | Egg. Industry | Software Compliance |
|---|---|---|
| Business Entity | Hatchery, Farms, Distribution | Design Firm, |
| | Houses, Retailers | Independent Software Vendor |
| | | (“ISV”), Customer |
| Touchpoints | Incubator, Conveyer Belt, | Product Milestones (E.g. Design Sign- |
| | Truck, Hen House, Storage | Off, Code Complete, Acceptance, |
| | Facility, Access Point etc. | Release) |
| Sensors | Automatic Temperature Gauge, | Code Conformance Tools, Unit Test |
| | GPS Transmitters, and mobile | Reports, |
| | device Application | |
| Observations | Temperature Reading, Bird | Source Code Quality Metrics, Defect |
| | Weight Measurement, | Metrics, Product Backlog Statistics |
| | Shipment Record, Sanitation | |
| | Records | |
| Compliance Policy | CFR 21, Part 118 (Egg Rule) | ISO 9001: 2000, CMMI |
| Rules | Environment Testing for SE, | Availability of Quality Management |
| | Monitoring of Pullets for SE | System Plan, Design artifacts and their |
| | Infection etc. | Reviews, Quality Review Checkpoints |

2.3 Relationships

This section explains an example of interrelationships between the Platform Elements described so far to help describe the high level interactions in the system, and how information may be represented.

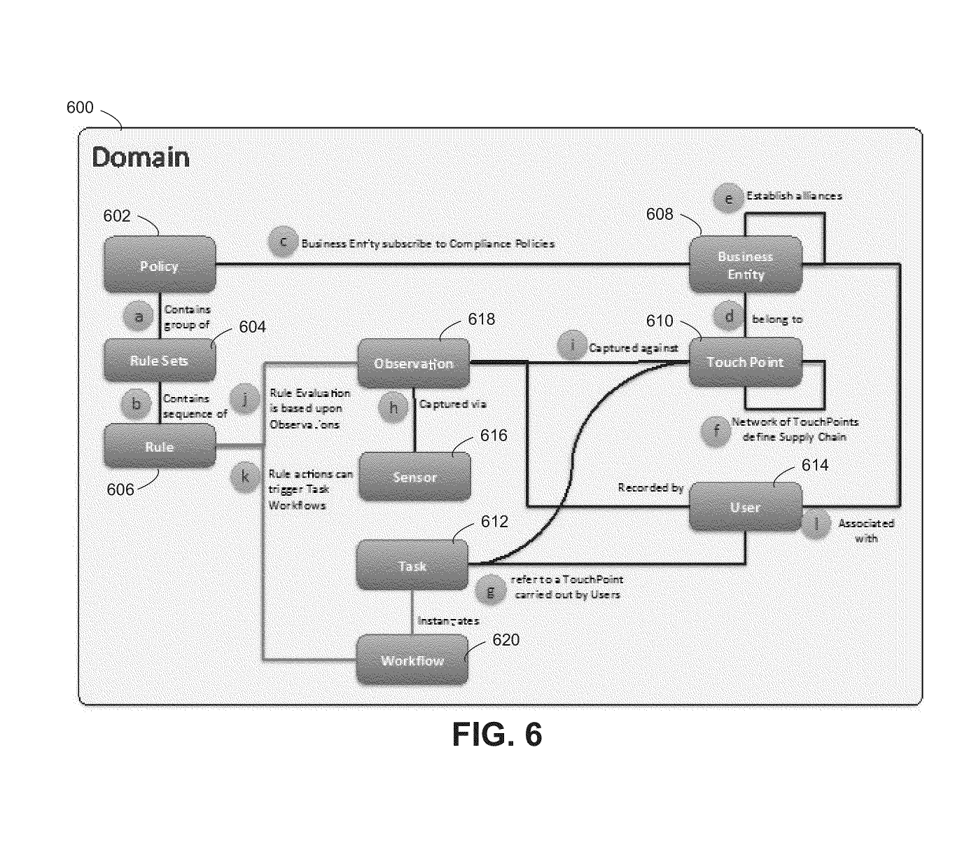

FIG. 6 is a functional block diagram providing an example of interactions between the different concepts in a Domain 600. The different interactions, labeled in FIG. 6, are described below.

a. Each Policy 602 may contain a group of RuleSets 604 that, in turn, may contain a sequence of Rules 606. Each RuleSet 604 may be grouped based on a type (class) of Touchpoints—for example, “Henhouse” or “Sprint Complete”.

b. In some embodiments, each RuleSet 604 may contain a set of Rules 606 that can be evaluated.

c. Policies may be subscribed to by Business Entities, such as Business Entity 608.

d. A specific Touchpoint 610 instance may belong to the Business Entity 608.

e. Business Entities, such as Business Entity 610, may themselves maintain relationships between each other, to represent end-end supply chains. When these associations are established, Business Administrators at both ends may establish detailed Touchpoint hierarchies that form the basis of Policy enforcement.

f. Touchpoints, such as Touchpoint 610, may be interrelated to each other by drawing lines that connect them within a Business Entity—for example, to indicate the flow of supplies and eggs between different locations (Touchpoints) in a Farm (business entity)

g. Tasks, such as Task 612, created in the System, can point to a Touchpoint, such as Touchpoint 610, where the action needs to be performed by the designated User, such as User 614. Note that data may also be gathered automatically—through an automated temperature sensor, for example—in which case a Task 612 may not be required.

h. As part of the Task 612 resolution, the User 614 may operate a Sensor, such as Sensor 616, to capture an Observation 618 into the System. Alternatively, an Observation 618 may enter the system by alternate means, such as automated sensors and from 3^{rd} party systems.

i. An Observation 618 captured in the System may refer to the Touchpoint 610 against which the Sensor 616 has collected the information. This may allow the Rules 606 to be retrieved (see “a”) for evaluation, based upon the type (class) of Touchpoint 610.

j. The Observation 618 may be available as an input into the Rule Engine, to test the values for Compliance.

k. Based on the Outcome of the Rules, Workflows 620 can be triggered to initiate remedial actions.

l. Users, such as User 614, which may have been created within a specific Business Entity 608, may have independent representation in the System so they can work with multiple Business Entities based on the access rights available to them. For example, Bob from “Joe's Exterminator” may work with several different farms, each with separate ownership.

m. Rules 606 may also be executed against a branch of the upstream “supply chain” graph as a whole, at a particular Touchpoint. For example, a Rule may determine, “have the Items being received at this Touchpoint passed through another type of Touchpoint” (for example, eggs through a washer).

The relationships described above are further illustrated through the Usage Scenarios mentioned in Section, ‘3. Solution Overview.’

2.4 Roles

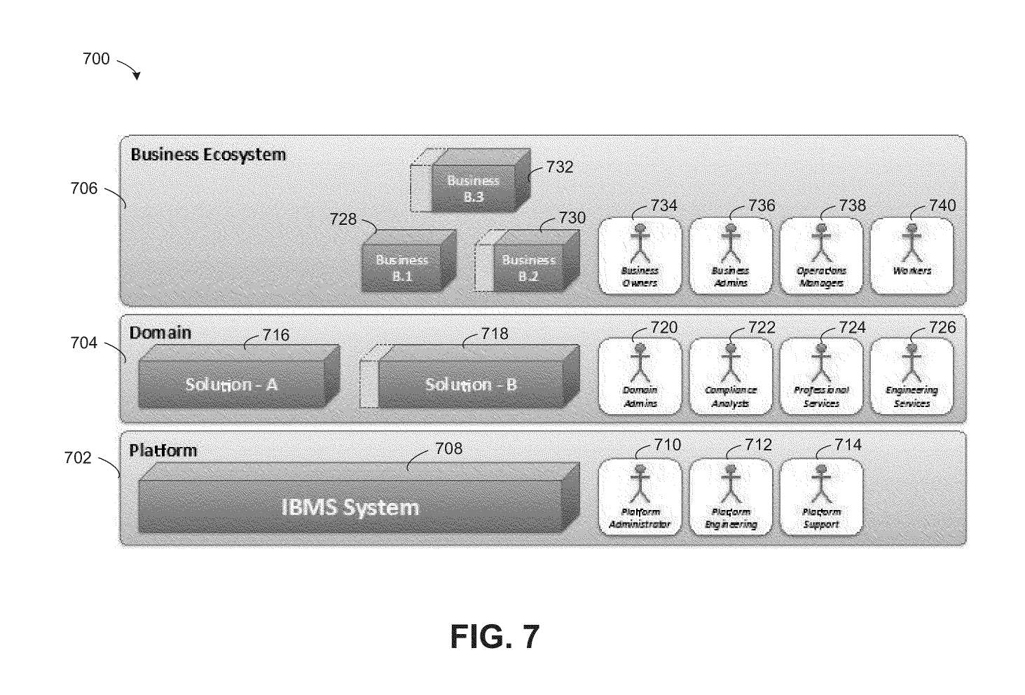

FIG. 7 is a schematic illustration of the Roles at various levels across the Platform and Solutions that are a part of a distributed work environment 700, according to some embodiments. In the example of FIG. 7, the distributed work environment comprises a Platform 702, a Domain 704, and a Business Ecosystem 706.

The Platform 702 may comprise an Intelligent Business Management Solutions (IBMS) System 708, and may involve various Roles including, but not limited to, the following. A “Platform Administrator” 710 is responsible for administering the overall operation of the Platform 702. He or she monitors to ensure that the System 708 can scale to accommodate business needs, and that it is configured for efficient ongoing operations. A “Platform Engineering Team” 712 is responsible for developing Core-Components of the Platform 702 that can be used to structure targeted Solutions for Business verticals with minimal investments. A “Platform Support Team” 714 ensures smooth operations, and makes sure that customer complaints are promptly addressed.

The Domain 704 may comprise one or more Solutions, such as Solution-A 716 and Solution-B 718 in FIG. 7, and may involve various Roles including, but not limited to, the following. A “Domain Administrator” 720 is responsible for provisioning of a new domain and working with Compliance Analysts 722 to ensure that the industry practices are effectively represented using the extension points of the underlying Platform 702. A “Compliance Analyst” 722 works with Subject Matter experts of the target Business Vertical to map the Policy and Workflow to the needs of the Domain 704; in particular by creating Rules, default Tasks and other artifacts, and carries a goal to ensure Operational efficiency, and high level of compliance for the given Domain 704. “Professional Services” 724 assists businesses in representing their company-specific operations in the System 708 for their specific Domain 704, and works with Engineering Services Team 726 to help build any Custom Extensions needed for specific businesses, to provide input into the product roadmap, and to maximize system adoption. An “Engineering Services team” 726 builds Applications, and 3rd Party Extensions for a specific Domain 704. Engineering Services Team 726 works in close collaboration with Compliance Analysts 722 and Professional Services 724 to make sure that the needs of the end users are met through efficient targeted Applications and Interfaces.

The Business Ecosystem 706 may comprise one or more businesses, such as Business B.1 728, Business B.2 730, and Business B.3 732 in FIG. 7, and may involve various Roles including, but not limited to, the following. A “Business Owner” 734 represents a person who owns and operates one of more Business Facilities in the IBMS System 708, and may be responsible for signing-up with the Services, and accepting the terms of the Compliance Policies that the Business needs to operate against. A “Business Administrator” 736 ensures an efficient representation of the operations of the Business in the IBMS System 708 by using self-service applications and, when needed, working with the Professional Services team 724 to make sure that the Touchpoint relationships, Task Workflow Templates, and Sensors conform to the way the Business operates. The Business Administrator 736 may also establish association with Business Partner systems registered in the IBMS System 708. An “Operations Manager” 738 co-ordinates the daily activities, and manages the facility and its workers. A “Worker” 740 represents staff members of the Business facility, who are responsible for carrying out Tasks assigned to them.

2.5 Setup a Domain

In some embodiments, setting up a new Domain comprises developing a targeted Solution for a particular Business Vertical, on top of the IBMS CMS Platform. Such initiatives may be executed as a Project involving a team of SMEs, Analysts and Engineers, or may be performed by third-party development companies using IBMS-supplied tools and interfaces packaged as a “Software Development Kit” or SDK. It should be appreciated, however, that these are merely illustrative examples, as embodiments are not limited in this regard.

In some embodiments, the output of this effort may be a domain-specific configuration package that may be used to set up a new instance of the CMS platform for that domain. In some embodiments, the same instance of CMS may not necessarily be used for completely distinct domains—for example, the same instance of CMS may not be used for both Food Safety and Aviation. In general, the precise dividing point where a new instance needs to be created is not limiting, and may be any suitable point based on the particular domains and business involved. It may be useful, for example, that different types of Food Safety—for example—could all be in the same instance since there are strong communalities in the supply chain. On the other hand, the partitioning of instances may simplify name spaces, administration and deployments. Precise definitions of the scope of the domains in each CMS instance may be determined on a case-by-case basis.

In some embodiments, to set up a new domain, the Platform Administrator may instantiate the new Domain, and the Domain Team may work on mapping the CMS platform to the specific Industry Vertical. This may involve study of the Target domain and ensuring that the Terminologies, Processes, Regulation and Roles are mapped to the concepts defined by the Platform such as Touchpoints, observations and the like.

Some examples of the high level activities that may be involved in such projects are described under this section (although it should be appreciated that embodiments are not limited to these particular activities):

2.5.1 Setup of Master Types

The Platform Administrators define a new Domain, and work with the Domain Team to define the “Master Type”s associated with the Domain. These include Touchpoint Types, Touchpoint Association Types, Sensor Types, Business Entity Types, Observation Data Types and other domain-specific standard attribute types in the system.

2.5.2 Map Roles and User Groups

Platform Administrators setup Domain Administrators and give them the required set of permissions for the specific domain. The Domain Administrators then provision Compliance Analysts, Professional Services Agents and Services Engineering Team for the Domain as needed. Each of these Roles is described earlier under the Section ‘2.4 Roles.’

IBMS system has an administrator who has access to modify the credentials of the Platform Administrators.

2.5.3 Define Standard Compliance Policies and Rules

Compliance Analysts and SMEs study the standard Compliance Policies for the Target Domain, and map them against Rules and Actions that can be represented in the IBMS Platform. The team will use a Rule Authoring tool to capture the conditions, and the recommended actions (“handlers”) evoked when those rules are triggered. The new Rules are then published as ‘Standard’ Compliance Policies that are available for all Business Entities to review and subscribe to.

2.5.4 Setup Workflow Templates

Compliance Analysts create Workflow Templates that map to the requirements of the target domain. Some workflows may be triggered based on rule violations, while others are simply part of task assignments, depending on the needs of the particular domain. The Workflow Templates consist of all Standard Task Types and Templates, State Transitions, Escalation Paths, Scheduled Tasks and specify their correspondence to Standard Touchpoint Types defined in the System.

2.5.5 Create Targeted Applications and Adapters

Engineering Services will build applications that the Users in the Domain will use for their routine operations, and for capturing the observations into the System. These Applications will be designed keeping in mind the User Experience of the Target domain, and will either be ‘custom built’ for their needs, or configured from generic end-user and management applications.

The ‘custom built’ experience has the advantage that it can be made specific to a domain, giving a high degree of ease of use; the “generic configured” approach has the advantage of speed and low cost, once the configurable applications are available. We recommend a custom-built user experience for the first several domains until patterns of use are well established, followed by the generalization into a configurable application.

Engineering Services team will also develop adapters to 3rd Party Services, which allow for Observations to be streamed into the System, and Alerts to be propagated to them.

2.5.6 Register Sensors and Third Party Application Access

Domain Administrators will register the Applications and Third Party Adapters (i.e. Sensors) into the System, giving them the required API Level Access, and security certificates. Depending on the domain these sensors can include hand-held devices (e.g. mobile devices) used by workers; automatic sensors, such as temperature sensors; and interfaces into third-party data streams, such as weather data or bills of lading for received supplies.

2.5.7 Define Standard Reporting Templates

Design Report Templates that are relevant to the Business Vertical, and provide overall visibility into Compliance Adherence, Workflow and Operations Status and Trend based monitoring.

3. Solution Overview

This section describes examples of how the IBMS Platform may be used to develop Solutions for specific Industry verticals, according to some embodiments. The fact that the Usage Scenarios taken into consideration under this section are specific to a particular industry, and uses terminology relevant to that industry, should not be taken to imply the solution is specific to that industry. The Compliance Management System is intended as being applicable across many different domains; the one selected here is for purposes of illustration only.

For the purpose of illustrating the Platform's flexibility to address the needs of different industry verticals, Egg Safety and Software Compliance are presented herein as examples.

3.1 Usage Scenarios—Egg Safety

3.1.1 Provisioning a New Business Entity

Provisioning is the process onboarding Business Parties that are collaborating in the supply (or demand) chain. Given the large number of Businesses involved in the Egg Industry that need to be registered with the IBMS System, this process may be designed to be as self-service as possible, and may provide easy tools that Business Owners can use to represent their particular operation efficiently in the system.

This following section describes examples of high-level steps involved in the provisioning process, according to some embodiments.

3.1.1.1 Registration

IBMS may offer a Self-Service Signup Portal that is available for all Businesses. This process may involve, for example, going through a Signup wizard that collects critical business information, and registers the Business Entity in the IBMS System. This process may involve validation of some critical business attributes, and other means of establishing valid identity (e.g. email/credit-card validations, or manual approvals)

The System may allow a Business owner to enroll into a Services Plan. Although the specifics of the Subscription plan are not a limiting factor to embodiments, the Architecture and Design may have provisions for standard SAS based pricing models. For example, the IBMS System may choose to keep pricing models based on number of registered businesses that a retailer may have under their infrastructure.

Also, the Business Owners may have a provision to create a Business Administrator, who may have the necessary permissions to setup the Operations Infrastructure for the Business.

3.1.1.2 Defining Operations Infrastructure

In some embodiments, Business Owners may use an interface provided by the System that allows them to Model their “internal Supply Chain”, and establish linkages with other registered partners.

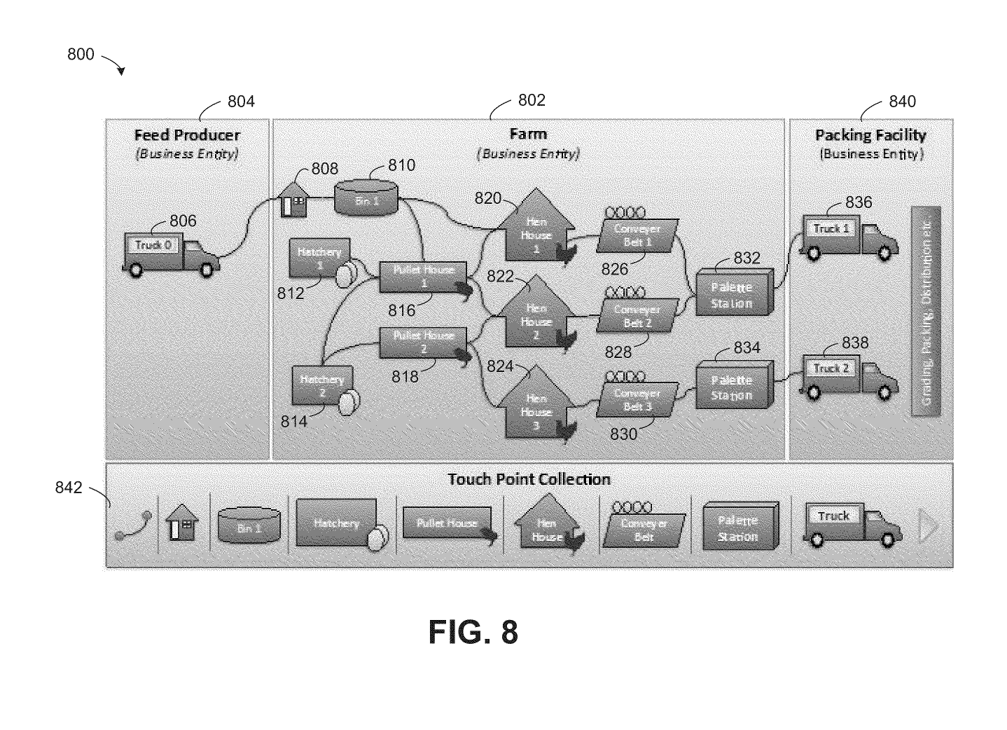

FIG. 8 is a schematic illustration of an example of one such “internal Supply Chain” 800 that may be modeled by a particular Farm Owner. The internal supply chain 800 comprises an end-end cycle on a specific Farm 802, comprising: a Feed Producer 804 providing bird feed via Truck 806 which is received at Receiving Station 808. The bird feed may be stored in Bin 810. The internal supply chain 800 may also comprise hatching eggs in one or more Hatcheries, such as Hatchery 812 and Hatchery 814, growing the birds in Pullet Houses, such as Pullet Houses 816 and 818, and moving the grown birds to Hen Houses, such as Hen Houses 820, 822, and 824, wherein the grown birds may lay eggs. The laid Eggs may be transferred via one or more Conveyer Belts, such as Conveyer Belts 826, 828, and 830, to Palette Stations 832 and 834. The palettes may then be delivered to a Packing Facility 840 for Distribution.

Also illustrated in FIG. 8 are some possible Touchpoint nodes 842 in the “internal Supply chain” 800. The Touchpoint nodes may map to the physical structure of the business, and may form the basis for Task Management, Capturing Observations and performing Compliance Validation. It should be appreciated, however, that the exact numbers and types of entities involved in the internal supply chain of FIG. 8 are not limiting, and any suitable number of trucks, receiving stations, feed bins, hatcheries, pullet houses, hen houses, conveyer belts, palette stations, and Touchpoint nodes may be used.

3.1.1.3 Establishing Partner Alliances

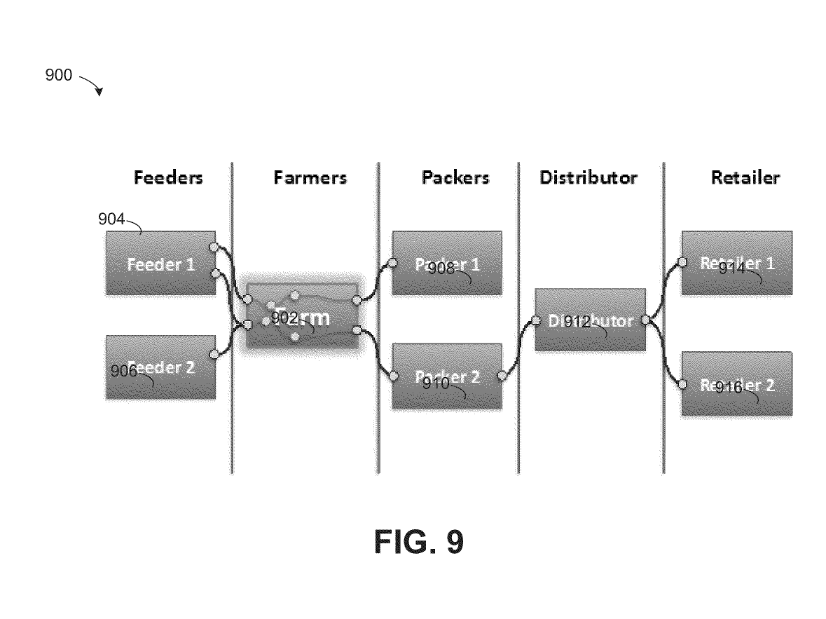

In some embodiments, partner alliances may be created based upon the Touchpoints that exchange goods/information between Businesses. FIG. 9 is a schematic illustration of an example of partner alliances 900 that may be established between Businesses. For example, a Business Owner, such as a Farmer of Farm 902, may make an alliance request to an “upstream” (supplier), such as Feeders 904 and 906, or “downstream” (customer) Business entity, such as Packers 908 and 910. When the request is approved, each Business may receive information about Touchpoints in the other Businesses that it can interface with. Once these Touchpoints interfaces are established between the Businesses, the Compliance Policies defined by the downstream (customer) Business may be inherited by the suppliers upstream in the Touchpoint hierarchy.

Partner alliances may also be established, for example, between Distributor 912 and upstream suppliers Packers 908 and 910, and downstream customers Retailers 914 and 916.

3.1.1.4 Managing Compliance Subscriptions

In some embodiments, Policies subscribed by Business Entities may be associated with registered Touchpoints by the Business Administrator. For example, when a Policy is associated with a Touchpoint, then all “upstream” (supplier) Touchpoints may also inherit the same policy. Due to this relationship, the supplier Business Entities may also inherit the Policies that are subscribed by their customers.

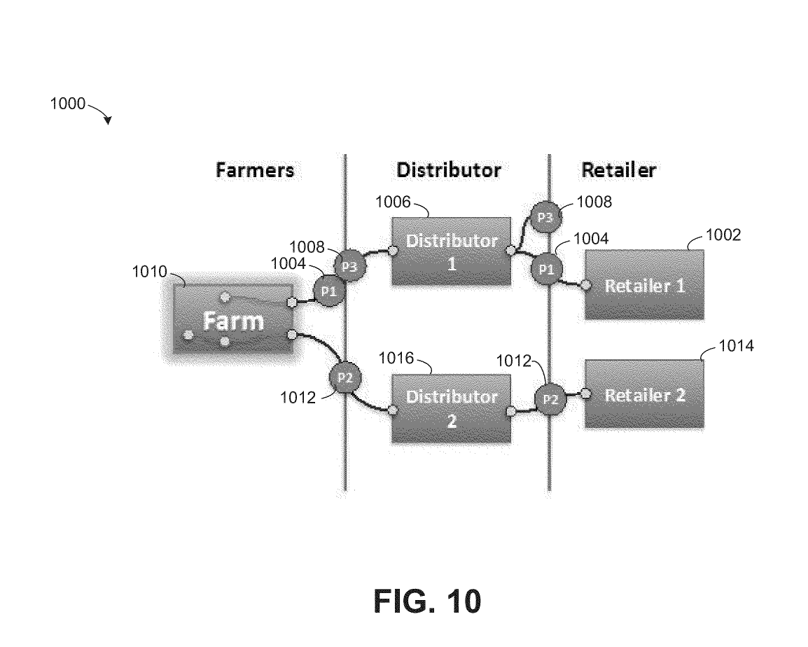

In some embodiments, at any point in the chain, a Business may associate Custom Policies that it wants to abide by, in addition to the ones that it inherits from its customers (downstream nodes). FIG. 10 is a schematic illustration of policy inheritance and association in partner alliance 1000. Retailer 1 1002 may specify Policy P1 1004 against its primary Checkpoint. In this case Distributor 1 1006 inherits Policy P1 1004, and also creates a custom Policy P3 1008, which it associates with its Touchpoint. Therefore Farm 1010, which provides goods to Distributor 1 1006, must also comply with Policy P1 1004 and Policy P3 1008. The Farm 1010 also inherits Policy P2 1012, through the inheritance chain from Retailer-2 1014, through Distributor-2 1016.

3.1.2 Capturing Observations

3.1.2.1 Capturing Observations Via Supported Applications

In some embodiments, the IBMS System may support Applications that assist Workers in the daily operations, and may help them report their Observations into the System.

In the Egg Safety example, one of these application may be the FarmHand mobile device App, that assists Farm Workers to carry out their routine Tasks. In some embodiments, these Tasks may direct Workers to carry out operations against a Farm Facility, and capture the outcome of these as Observations in the System. For instance, consider the following non-limiting example scenario:

3.1.2.1.1 Flock Weight Measurements

A Farm worker receives a Task on his Farm-Hand mobile device Application to take weights of Birds in Hen House 3. The Farm worker reached Hen House 3, and checks-in into the Location. The Farm Worker then captures the weight of 10 Birds into the Farm-Hand application, measuring one Bird at a time. The Farm Worker reviews all the 10 readings captured by the application, and finally submits the reading into the System. The Task is marked complete.

In the above example, ‘Hen House 3’ represents a Touchpoint. Farm Worker represents the ‘Actor’ who is carrying out the Task. The Observation is the weight of 10 Birds, and the Sensor is the instance of the Farm Hand mobile device App, via which the Observation is submitted.

Further detail about the Technical representation of this Use Case can be found under the following Architecture section.

3.1.2.1.2 Truck Driver Carrying Feed into a Farm

Security Personnel at the Gate of the Farm register a Shipment of Feed that is arriving from a Producer. The Security officer validates and captures the following information into the Farm-Hand mobile device application:

Validates the identity of Truck, and makes sure it is from a registered Touchpoint in the System.

Makes sure that the Truck is Compliant against the Policy subscribed by the Farm

This makes sure that the Truck has maintained hygiene standards, temperature regulations and delivery schedules defined by the Policy.

Asks a Security questionnaire to the Truck Driver, ensuring that the truck and the driver have not been subjected to any contamination, and have maintained proper hygiene standards.

The Security officer, finally submits a Truck Entry Log into the System, which captures all of the above details.

In this scenario, the Security Officer (Actor) who is operating at the Security Checkpoint (Touchpoint) captures the Truck Entry Log (Observation) using the Farm-Hand mobile device Application (Sensor). The Observation also captures the Truck Identification (Source Touchpoint reference) making sure that it is compliant.

The section ‘3.1.3 Compliance Evaluation’ describes how the Observations captured in the above scenarios may be evaluated against Policies, according to some embodiments.

Further detail about the Technical representation of this Use Case can be found under the section—‘4.5.1 Truck carrying feed enters the security gate of farm.’

3.1.2.2 Data Feeds from 3Rd Party Systems

In some embodiments, the IBMS Platform may provide support for capturing Observations from 3rd Party Systems and Devices through a Web Services interface. 3rd Party Sensors can register with the IBMS Platform to obtain a Sensor-Id, and required security certificates using which they can post Observations into the System.

Other 3rd Party applications which collect data of interest to the system—for example bills of lading for trucks—may make Web Services call to the IBMS Platform to post the Observation.

An example Usage scenario for such Applications may include Mobile Logistics Application (Sensor), which periodically transmits Temperature and Location information (Observation) of Trucks carrying delivery (Touchpoint).

3.1.3 Compliance Evaluation

This section takes into consideration high-level Usage Scenarios related to Compliance Evaluation, according to some embodiments.

3.1.3.1 Evaluate if Observations are within Limits

Observations captured in the System provide input for Compliance Validations. One category of Compliance validations will be to check whether the Observations captured are be within permissible limits.

Consider the example scenario mentioned above for ‘3.1.2.1.1 Flock weight Measurements’, where the Observation captures the weight of a Bird Sample. In that Scenario, the Hen House represents the Touchpoint within which the Observation of Bird Weight Measurement is captured.

A Compliance Rule may designed to ensure that the Birds are within the correct weight boundaries for their age, and that the readings being captured are legitimate. For example, this rule may be constructed by retrieving the following parameters—Age of the Flock (from Touchpoint Attributes), Weight of Birds (Observation Data Payload). The rule may simply check the Average of the values, and compare it with a Weight-Chart by age. Alternatively or additionally, the Rule may check the Standard Deviation between weight measurements to ensure legitimate entries.

If the Compliance Rule fails, then the Touchpoint (i.e. the Hen House) could become Non-compliant, and the action could trigger an alert for a re-inspection.

The section ‘4.5.2 Farm worker perform task on henhouse’ describes examples of how such Rules may be represented in the System.

3.1.3.2 Rules to Check for Absence of Observations

In some embodiments, Non-Compliance may result due to lack of Observations being present in the System. For Instance, a Rule may expect that the Manure-Pit in a Hen House should be cleaned on a weekly basis. If there are no Observations captured over a period of one week which indicate that this activity has been carried out, then the Compliance Rule may fail for that Hen House, and may trigger a Task Workflow to carry out cleaning activities, and lab-testing.

The Architecture section describes how similar rules can be represented in the System. See section ‘4.5.2 Farm worker perform task on henhouse’.

3.1.3.3 Compliance Propagation

In some embodiments, Compliance Evaluation outcomes may be propagated within the System up the Supply Chain. These chain of propagation may be established through the Touchpoint relationships between the Business Entities (See section ‘3.1.1.4 Managing Compliance Subscriptions’).

According to some embodiments, if certain Rules within a Policy fail against a Touchpoint, then it may be marked as non-compliant, and the same status may be propagated to all parent Touchpoints that are dependent on this one. Hence, in the example of FIG. 10 above, if a Touchpoint in a Farm 1010 fails against Policy P2 1012, then the Distributor 2 1016 and Retailer 2 1014 (and their dependent Touchpoints) may be marked Non-Compliant against the same Policy.

3.1.4 Workflow Management

In some embodiments, the IBMS Platform may extend beyond compliance evaluation, and may provide features designed to ensure reduction of non-compliance incidents by attaining operational efficiency and adherence to standards. For example, this may be achieved through Human Workflow Optimizations. This section describes a few non-limiting examples of usage scenarios related to this area.

3.1.4.1 Task Instantiation

In some embodiments, a Policy that is subscribed by a Touchpoint may come along with a recommended set of Workflow Templates. These Workflow Templates may spawn Tasks based upon the Rules defined by the Compliance Analysts. In some embodiments, this may allow for the Workflow to spawn new Tasks based on an expected Schedule, or to create Tasks based on specific State of the Touchpoint.

These Tasks may guide the Operations Manager in making sure that their facilities are carrying out all the activities that will help maintain compliance.

For example, as explained under (i.e., ‘3.1.3.2 Rules to check for absence of Observations’) if there is a Rule within a Compliance Policy which checks of the Manure-Pit within a Hen House is cleaned on a weekly basis, then the Workflow Template associated with the Policy may automatically create a Task requesting the cleaning activities to be carried out every week for each Hen House.

In some embodiments, Workflow for spawning Tasks may also be triggered based on Actions defined within a Compliance Rule. Therefore a Rule within a Policy can trigger Workflow based on the outcome of the conditions. This may help creation of Resolution Tasks to contain the incidents of non-compliance.

For instance, if a Rule within a Policy were to observe that the Temperature levels in the Hen House have been higher than limits, then it may trigger a Workflow that may create a Task for examination of the ventilation ducts.

3.1.4.2 Automatic assignment of Tasks

In some embodiments, the Workflow System may have access to User Information, and also an understanding of the physical setup of a facility. This information may allow the Workflow engine to make intelligent choices related to assignment of Tasks. The Workflow Manager may support multiple types of assignment rules to be implemented, some non-limiting examples of which may be as follows:

Proficiency

Assign Tasks to Workers who have a successful history of carrying out Tasks of the same nature.

Availability

Assign Tasks to Workers based on their availability in the facility, and their current work-load.

Proximity

Assign Tasks to Workers based on their Physical proximity to the target Touchpoint.

In some embodiments, the Automatic assignment of Tasks may help further reduce human dependencies, and lead towards operational efficiency.

3.1.4.3 Self Administration and Escalation

In some embodiments, Workflow Templates may contain information about expected SLAs for each Task, across each state. These SLAs may help prepare target dates/schedules for Task resolutions. If Tasks are blocked or delayed, resulting in possible breach of SLAs, then the Workflow engine may be configured to either delegate the Task to a peer-worker, or escalate it to higher management for initiating corrective measures.

3.2 Usage Scenarios—Software Compliance

This section discusses some of the Usage Scenarios related to an example of Software Compliance, and illustrates how they may be represented through the IBMS Platform. It should be appreciated, however, that the specific features and actions described herein are merely for illustrative purposes, and are not limiting to all embodiments.

3.2.1 Capturing Observations

3.2.1.1 Metric Feeds from Continuous Integration Frameworks

In Software Engineering, the process of Continuous Integration (i.e. CI) typically makes sure that all developer branches are integrated into a common build and test process at a regular basis. This is designed to ensure that the Quality can be evaluated against common standards, and that the software components remain well integrated. Many useful Metrics can be collected through this process, which may give an objective assessment of the quality and readiness of the Software Product.

For instance, the CI Framework may execute the Unit-Test Cases, which may produce a report indicating the number of Tests passed, and the amount of Code that was covered through these Test.

In this example:

Engineering Team may represent a Business Entity

Job of Unit Test Case Execution may represent a Task

Test Execution and Coverage Report may represent an Observation

Sprint/Milestone may represent a Touchpoint

The CI Framework may contain Jobs that collect this information, and posts the Observation into the IBMS Platform. This may ensure that the information is automatically posted to the System during every build.

3.2.2 Compliance Evaluation

Referring to the CI Framework example above, a Compliance Rule may be constructed as follows.

A Policy Rule may be constructed to mark the Software Product non-compliant against a particular Milestone if it does not meet a Code Coverage threshold, or has failing tests.

Additional Rules may be constructed to check for existence of the Unit-Test Report Observations on a periodic basis. If these Observations are not coming against an expected frequency, then also a specific milestone may be marked non-compliant, since there is no evidence of Unit-Testing being carried out.

3.3 Non-Functional Requirements

In some embodiments, in order to support the operations of the Egg Industry the Platform may also need to support the following capabilities:

3.3.1 Multi Language Support

In some embodiments, the System may have support for multiple Language Packs, which may allow it to be deployed against multiple geographies. It may also be possible to specify their personal preferred language, which may help ensure that they get a customized user-experience, and provisions may exist for runtime translation of key information within the system.

3.3.2 Security Access Levels

In some embodiments, the System may support multiple levels of Security in the System. In addition to standard security tiers presented by PAAS layers, the System may provide controlled access based on User's privileges, and also inherit data-visibility constraints based upon structural hierarchy of Business and Touch-Point Hierarchies

3.3.3 Scalability

In some embodiments, the System may operate across a large number, for example tens of Millions, of facilities and their internal operations. In such scenarios, the system may work with a large volume of Observations captured from multiple sources, carry out complex time-sensitive analytics, and workflow management activities. The System may be able to linearly scale to handle these increasing demands.

For instance, grading-houses may produce a few million eggs a day, and Data Feeds from these facilities may be of similar volumes.

3.3.4 High Availability

In some embodiments, the System may service many Industries, some of which may be high-volume industries running on very low margins. Hence, in some embodiments, the System may be configured to maintain high levels of availability.

3.3.5 Ease of Integrations

In some embodiments, the System may provide a framework that allows it to connect with disparate data sources. As non-limiting examples, some of these data sources may include OMRON Data Feeds, Test Lab Integrations, and adapters to Machine Sensors, etc.

3.3.6 Logging and Record Keeping

In some embodiments, the System may maintain detailed logs and trails of Events, Activities and Messaging exchanged between the System components. The System Administrator may configure the expiry policy for this information.

In some embodiments, the System may be able to maintain large sets of Records and Documents that may remain easily retrievable for Audits.

3.3.7 Analytics

Provide support for ‘typical’ Business Intelligence (BI) tool capabilities by integrating with a third-party BI tool. Typical BI capabilities expected include, but are not limited to: filtering, sorting, pivoting, graphical visualizations, data-export (to Excel or PDF), drill-in/drill-down, geospatial visualization, ad-hoc reporting, email push, and alerting.

4. Architecture

4.1 Overview

In some embodiments, the compliance management system (CMS) may be a highly scalable, multi-tenant platform that allows collaborative business partners (participating in supply-chain and demand-chain across different industries) coming together to share their data such that end-to-end compliance can be efficiently checked. In some embodiments, from a functional perspective, the system may be broken down into the 3 parts; data collection, compliance management and provisioning. It should be appreciated, however, that embodiments are not limited to such segregation of parts, and any suitable functional organization of the system may be used.

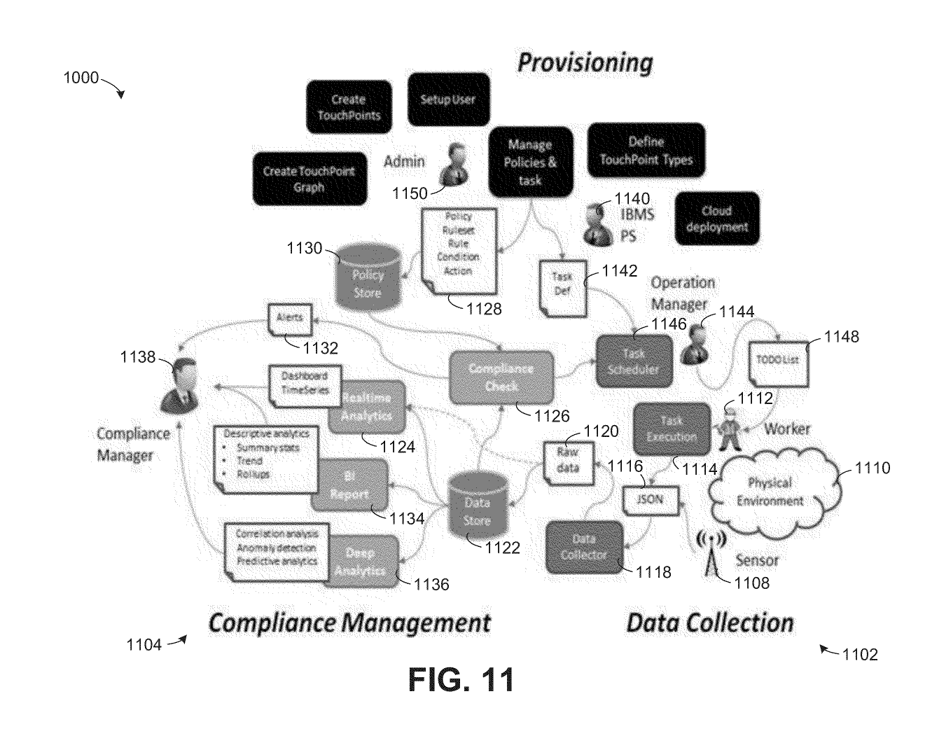

FIG. 11 is a schematic illustration of an example of a compliance management system 1100. In this example, the system 1100 comprises a data collection part 1102, a compliance management part 1104, and a provisioning part 1106.

4.1.1 Data Collection

The Data Collection part 1102 is responsible for collecting Observations of Touchpoints into the system 1100 where compliance check can be performed. Each Touchpoint is equipped with an appropriate sensor, such as Sensor 1108, from which observation data may be collected about the physical environment 1110. Sensor 1108 may be any suitable type of sensor and may be realized by a device embedded at the Touchpoint where data is continuously collected, or realized by scheduling a manual task done by a human worker 1112 who travels to the Touchpoint, reads and uploads the data from a handheld device. Regardless of how data is collected, various types of data, such as data from Sensor 1108 and Task Execution Data 1114 related to Worker 1112, may be transmitted in a suitable format, such as the JavaScript Object Notation (JSON) format 1116 to a Data Collector 1118. The Data Collector 1118 may stored the corresponding Raw Data 1120 in a data store 1122 and/or transfer the Raw Data 1120 to a Realtime Analytics module 1124.

4.1.2 Compliance Management

As the core of the overall system 1100, the Compliance Management part 1104 may be responsible for analyzing the data collected for each Touchpoint. The data may be checked using Compliance Check module 1126 which may use a set 1128 of policies and rules stored in a Policy Store 1130. At appropriate times, a compliance engine may perform validation of latest status of these Touchpoint and in case of failure, it may send an alert 1132 or take automatic remedial actions.

In some embodiments, Compliance Management part 1104 may provide a summary of overall compliance status and trends by means of various BI reports 1134 and a real-time dashboard. In some embodiments, this may also be an extension point of incorporating advance analytic functions 1136 such as predictive analytics, correlation analysis, anomaly detection and automatic optimization. In some embodiments, the various types of alerts, summaries, and other results of analyzing the raw data 1120 may be presented to a Compliance Manager 1138.

4.1.3 Provisioning

The Provisioning part 1106 may be responsible for onboarding the system 1100 for a particular industry, including what IBMS professional services (PS) 1140 need to do to define the Touchpoint schema, standard compliance rules 1128, as well as necessary deployment configuration. In some embodiments, the IBMS PS may provide a Task Definition 1142 to an Operation Manager 1144 via a Task Scheduler 1146. Based on the scheduled tasks, the Operation Manager 1144 may create a TODO List 1148 to provide to a Worker 1112. On the other hand, the Provisioning part 1106 may also cover how a business entity within the supply chain declares which policy it complies, and how the Touchpoints they own is connected with their business partners within the supply chain. In some embodiments, a system Administrator 1150 may create various component of the Touchpoints, setup users, and/or mange policies and tasks.

4.2 Component Architecture

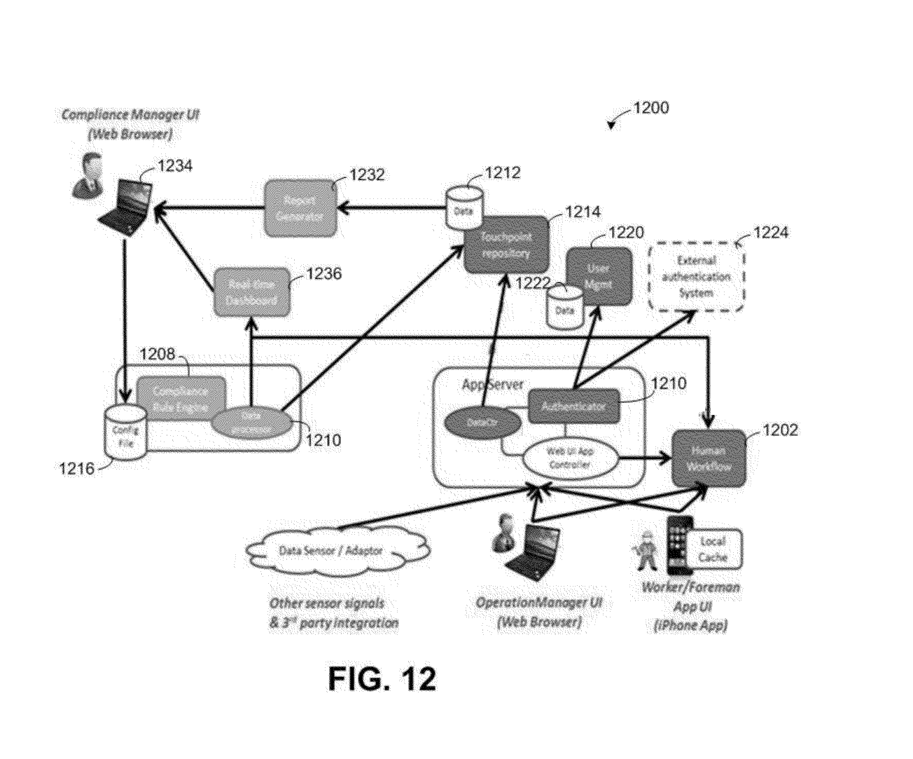

FIG. 12 is a schematic illustration of an overall architecture of an example compliance management system 1200, according to some embodiments.

4.2.1 Workflow System

In some embodiments, the workflow system 1202 is responsible for scheduling manual tasks and corresponding operations such as task creation and worker assignment. It may also keep track of the status (with a persistent data storage mechanism), monitor its completion and perform necessary escalation.

Interface

The workflow system 1202 may provide both visual user interface (UI) and programmatic application programming interface (API), such as an Operations Manager UI 1204 and/or a Worker/Foreman App UI 1206, for various functions including, but not limited to, the following functions:

Add or remove users and user groups.

Create workflow template, which is a graph contain activities.

Instantiate a workflow instance with input parameters.

For manual activities, assign human workers.

Provide basic statistic of workflow execution.

Dependencies

Depend on User Manager for more detail user profile information.

Persistent State

The workflow system 1202 may store various types of data including, but not limited to, Workflow template definition and Workflow instance and their current status.

4.2.2 Compliance Rule Engine

The Compliance Rule Engine 1208 may be responsible for performing compliance checks on Touchpoints against compliance policies. The checking may be performed via a data processor 1210, for example, based on a time scheduler, or an incoming API call. Compliance Rule Engine 1208 may read Touchpoint data from a data store, such as data store 1212 in Touchpoint Repository 1214, and evaluate against compliance rules and then store the compliance status back to the data store 1212.

Interface

Compliance Rule Engine 1208 may provide programmatic API for various functions including, but not limited to, evaluating a Touchpoint against one or more relevant compliance policies.

### Dependencies

Compliance Rule Engine 1208 may depend on the Touchpoint repository 1214 where the data about Touchpoints is stored.

Persistent State

Compliance Rule Engine 1208 may store the compliance policies, for example, as a Configuration File 1216.

4.2.3 Authenticator and User Manager

In some embodiments, the Authenticator system 1218 may be responsible for user login to gain access to the system 1200.

Interface

In some embodiments, the incoming interfaces may be over a suitable API, one example of which is a Representational State Transfer (REST) API, from the end user clients. The interface may allow authenticating user id and user credentials.

Dependencies

The authentication system may depend on various systems, including but not limited to, the following systems:

A User Manager 1220 which hosts the user's credential information, which may be stored in a local data store 1222.

An external 3rd party authentication system 1224 (e.g. owned by the supplier's IT)

Persistent State

The User Manager 1220 may have an internal user database 1222.

4.2.4 Data Controller

In some embodiments, Data controller 1226 may be responsible for accepting incoming calls from one or more sensors, such as Data Sensor 1228 (which can be an App or external sensors). It may receive the observations and merge them into the Touchpoint repository 1214 of the corresponding Touchpoint.

Interface

The Data controller 1226 may use a Web UI App Controller 1230 to provide a listener interface. For example, the listener interface may be provided via HTTP POST command, where data is encoded in any suitable format. As a non-limiting example, data may be encoded in JSON format as follows:

```
[
  {
        “header”:
        {
        “touchpoint_id”: “henhouse22”,
        “sensor_id”: “app53”,
        “user_id”: “joe”,
        “timestamp”: 1002389
        },
        “body”:
        {
        “attribute1”: 11,
        “temperature”: 67,
        “chickenMeasure”: {JSON String}
        }
  },
  {
        “header”: { ... },
        “data”: { ... },
  }
]
```

Dependencies

In some embodiments, the Data Controller 1226 may update the Touchpoint repository.

Persistent State

In some embodiments, the Data Controller 1226 may be stateless.

4.2.5 Touchpoint Repository

In some embodiments, Touchpoint repository 1214 may be responsible for storing information about one or more Touchpoints, including but not limited to: metadata (e.g. id, owner, type) and various attributes observation history (e.g. attribute name and a time series of attribute observations) as well as compliance check history (e.g. which compliance has failed), and the supply chain connectivity (which Touchpoints are dependent on me).

Interface

In some embodiments, the Touchpoint repository 1214 may provide a REST-ful CRUD interface based on a MongoDB API. It should be appreciated, however, that embodiments are not limited to a particular choice of API or programming format, as any suitable interface technique may be used by Touchpoint repository 1214.

Dependencies

In some embodiments, the Touchpoint repository 1214 may not have other dependencies.

Persistent State

In some embodiments, the Touchpoint repository 1214 may store information related to one or more Touchpoints

4.2.6 Data Processor

In some embodiments, Data processor 1210 is responsible for validating Touchpoint compliance. It may periodically scan the Touchpoint repository 1214 on various Touchpoints and check against the compliance rules, and send alert for non-compliance.

Interface

In some embodiments, the data processor 1210 may not directly provide an interface.

Dependencies

In some embodiments, the data processor 1210 may depend on the Touchpoint repository 1214 where it looks for Touchpoint data. It may also call the compliance rule engine 1208 to validate if received data conform to the compliance rules.

Persistent State

In some embodiments, the data processor 1210 may be stateless.

4.2.7 Report Generator

In some embodiments, Report generator 1232 is responsible for generating reports to a Compliance Manager UI 1234. Such reports may be used, for example, for business intelligence. The Report generator 1232 may pull data from the Touchpoint repository 1214 according a set of predefined report template.

Interface

Report generator 1232 may provide a web UI interface, such as Compliance Manager UI 1234, where reports can be viewed online.

Dependencies

In some embodiments, Report generator 1232 may read data from the Touchpoint repository 1214.

Persistent State

In some embodiments, Report generator 1232 may store the report template.

4.2.8 Realtime Dashboard

In some embodiments, Realtime dashboard 1236 is responsible for displaying time series numeric data once it is received. For example, it may provide an immediate visualization on trends.

Interface

Realtime dashboard 1236 may provide a set of data visualization widgets embedded in a web UI interface, such as Compliance Manager UI 1234. It may also provide an API whether real-time data can be pushed in.

Dependencies

In some embodiments, Realtime dashboard 1236 may have no other dependencies

Persistent State

In some embodiments, Realtime dashboard 1236 may store a sliding window of real-time data that has been pushed in.

While some specific examples of various features in a compliance management system have been provided in connection with FIG. 12, it should be appreciated that these examples are not limiting. In general, embodiments may use any specific programming language, data structure, or user interface technique to provide a compliance management system that collects data from an environment, analyzes the data against a set of rules, and provides alerts and/or reports based on the analysis.

4.3 Supply Chain Network Graph

The supply chain network graph provides important information to keep track of compliance along the supply chain. In some embodiments, the supply chain network graph may be a directed acyclic graph where each node is a Touchpoint instance (owned by some business entity) and each directed edge represents the dependency between Touchpoints (e.g. an edge from Touchpoint x to Touchpoint y means y depends on x). In some embodiments, if the graph disallows circular dependencies, then the graph may be acyclic (i.e., contains no cycles).

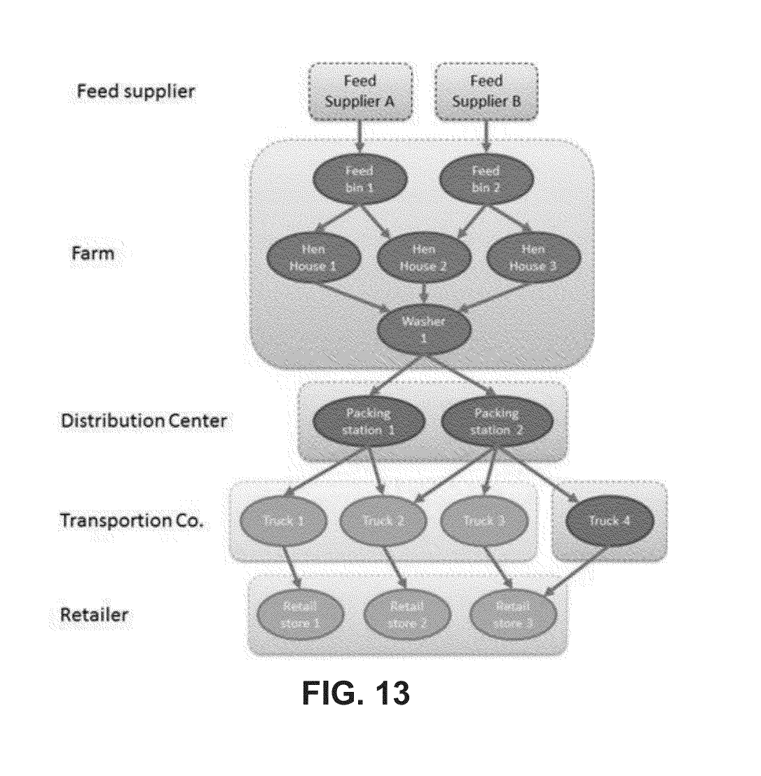

FIG. 13 is a schematic illustration of an example connectivity graph 1300 for one possible supply chain network, according to some embodiments. The supply chain graph 1300 illustrates dependencies between Retailers 1302, Transportation Companies 1304, Distribution Centers 1306, Farms 1308, and Feed Suppliers 1310.

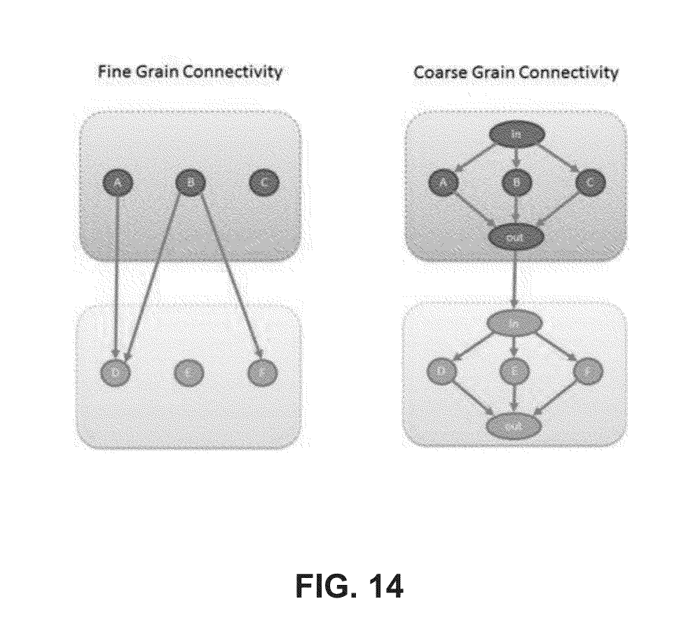

In the example of FIG. 13, the connectivity may be at its finest grain where a business entity keeps track of every Touchpoint owned by its business partners. In some embodiments, tracking may occur at a coarser grain where at artificial Touchpoint is created at the entry and exit point of the business entity. FIG. 14 is a schematic illustration of an example of both fine-grained tracking and coarse-grained tracking. In a fine-grained connectivity scenario 1400, business entity A 1404 may keep track of Touchpoints in business entity D 1406, while business entity B 1408 may keep track of Touchpoints for each of business entities D 1406 and F 1410. In this example, business entity C 1412 may not keep tack of any Touchpoints and business entity E 1414 may not have any Touchpoints tracked.

By contrast, in the example of a coarse-grained connectivity 1402, there may be artificial Touchpoints, such as Touchpoints 1416 1418, 1420, and 1422, created at the entry and exit of each group of business entities. In this example scenario, business entities A 1404, B 1408, and C 1412 may each have access to the same tracked information collected from each of business entities D 1406, E 1414, and F 1410. As such, a coarse-grained connectivity scenario 1402 may not allow the level of customized configuration to track individual business entities comparable to that of the fine-grained connectivity scenario 1400.

In some embodiments, as business entities change their business relationships, the graph connectivity topology may be dynamic and change over time.

4.3.1 Propagation of Compliance Requirement

In some embodiments, if Touchpoint A points to Touchpoint B (B depends on A), then all the compliance policy that B conforms may become a requirement to A as well. In other words, Touchpoint A may be evaluated against policy A and the business entity who owns Touchpoint A may have a violation handling file to define what actions should be taken when Touchpoint A is detected to have failed the compliance check.

In case of automatic binding, when Touchpoint A is connected to Touchpoint B, the system may automatically add all compliance policies that B has conformed to A as well. The business entity who owns Touchpoint A may be notified of these additional compliance requirement and may define the appropriate violation actions.

In case of explicit binding, when Touchpoint A is connected to Touchpoint B, the system may check if all of B's compliance policies is supported in A. If not, it may disallow the connection to be formed.

4.3.2 Validation of Distribution Path

In some embodiments, a Touchpoint may optionally require that all paths that reach it must go through some other types of Touchpoints, (e.g., Walmart may declare that all eggs need to go through a particular washer Touchpoint). As a non-limiting example, such validation may be done by the following algorithm.

Given a Touchpoint X, the system conducts a breath-first search to collect all paths that reaches X.

For each path, it converts the Touchpoint id into Touchpoint type.

Then it check whether the path contains the subsequence required by the Touchpoint X.

4.4 Policy Engine Design

This section will describe in more detail one possible example of the policy engine execution, according to some embodiments.

4.4.1 Compliance Policy

In some embodiments, a compliance rule may provide public information and specify a set of Boolean conditions that need to be true in order to fulfill the compliance requirement. For example, it may be organized in a hierarchy of Touchpoint type, check frequency, preconditions and check condition. Touchpoint type may define under which Touchpoint type such rules will be applied. A check interval may determine how often the rule will be checked. A precondition may define whether the rule should be checked. If so, check conditions defines the condition that need to be evaluated to be true in order for the corresponding Touchpoint to be considered as compliant.

The following is a non-limiting example of a compliance rule definition file:

```
Import:CDCCompliance
Var:MIN_TEMP_LIMIT = 10
Var:MAX_TEMP_LIMIT = 40
Var:MIN_CHICKENS_TO_WEIGH = 20
Var:MIN_VARIANCE_CHICKEN_WEIGH = 0.25
Var:MIN_CHICKEN_WEIGH = 2
Var:MAX_CHICKEN_WEIGH = 4
TouchpointType:Truck
  rule:MIN_TEMP_RULE
        check_interval: 300
        check:
            max(temperature.within_minutes(60)) <
            MIN_TEMP_LIMIT
        end_check
  end_rule
  rule:MAX_TEMP_RULE
        check_interval: 300
        check:
            min(temperature.within_minutes(60)) >
            MAX_TEMP_LIMIT
        end_check
  end_rule
end_TouchpointType
TouchpointType:Henhouse
  rule:RESULT_PASS
        check_interval: 300
        precondition:
            len(chicken_weights) > MIN_CHICKENS_TO_WEIGH
        end_precondition
        check:
            stdev(chicken_weights) >
            MIN_VARIANCE_CHICKEN_WEIGH
        end_check
  end_rule
  rule:NORMAL_WEIGHT
        check_interval: 300
        precondition:
            len(chicken_weights) > MIN_CHICKENS_TO_WEIGH
        end_precondition
        check:
            min(chicken_weights) > MIN_CHICKEN_WEIGH
            max(chicken_weights) < MAX_CHICKEN_WEIGH
        end_check
  end_rule
end_TouchpointType
```

4.4.2 Violation Handling

Violation handling may be defined in another file what to do if a Touchpoint fails its compliance check, at the rule level (when a rule is violated) or at the Touchpoint level (when any of the rule is violated). Violation handling may be private to the business entity who subscribes to the compliance policy.

In some embodiments, 3 types of actions may be supported, though it should be appreciated that embodiments are not limited to any particular number or type of actions:

Sending an alert to the business entity

Invoke a script with parameters

Instantiate a workflow instance with a name and parameters

The following is a non-limiting example for a violation-handling file.

```
Reference:FDACompliance
TouchpointType:Truck
  Touchpoint_complaint_to_noncompliant: exec(“scriptX”)
  Touchpoint_noncomplaint_to_compliant: exec(“scriptY”)
  rule:MIN_TEMP_RULE
          complaint_to_noncompliant: send_alert( )
          noncomplaint_to_compliant: send_alert( )
  end_rule
  rule:MAX_TEMP_RULE
          complaint_to_noncompliant: send_alert( )
          noncomplaint_to_compliant: send_alert( )
  end_rule
end_TouchpointType
TouchpointType:Henhouse
  rule:RESULT_PASS
          complaint_to_noncompliant: exec(“script1”, “param1”,
          “param2”)
          noncomplaint_to_compliant: send_alert( )
  end_rule
  rule:NORMAL_WEIGHT
          complaint_to_noncompliant:
          start_workflow(“MeasurementTask”, “userGroup2”)
          noncomplaint_to_compliant: send_alert( )
  end_rule
end_TouchpointType
```

4.4.3 Capturing Touchpoint Observations

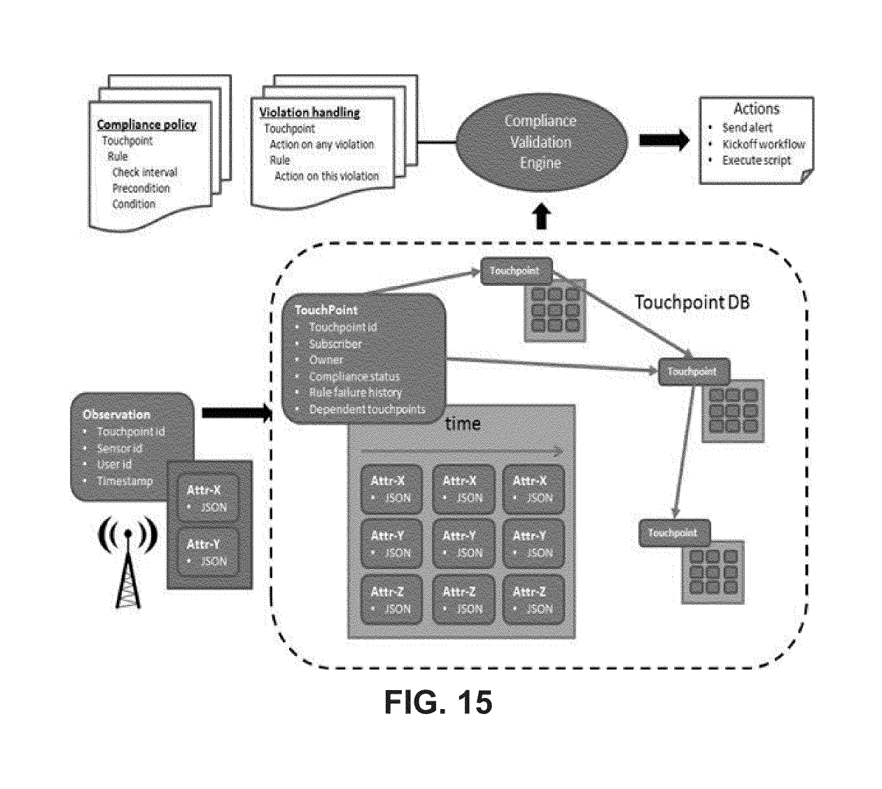

FIG. 15 is a schematic illustration of an example of a portion 1500 of the compliance management system detailing how the observations of Touchpoints may be captured into the backend storage.

First of all, information about the Touchpoint may be captured via some sensor(s), such as sensor 1502. Sensor 1502 may be a device attached to the Touchpoint (e.g. a thermometer attached to a truck) and send the observation continuously into the system. Alternatively, sensor 1502 may be a manual task where a human worker is assigned with a task, visit the Touchpoint and record the data via a mobile device application. Data collected by the sensor, such as observations 1504, may be uploaded to the IBMS CMS backend using any suitable communication protocol, such as the HTTP protocol. The observations 1504 may be related to one or more attributes 1506 that the sensor 1502 is configured to observe or collect.

In some embodiments, observations 1504 uploaded from sensor 1502 may be merged into the Touchpoint DB 1508 where various details of Touchpoints are stored. As one example, the Touchpoint DB may utilize the MongoDB, though embodiments are not limited to any particular type of database or database query language. Each Touchpoint type may have any suitable format. In some embodiments, there may be one Collection 1510 per Touchpoint type. As a non-limiting example, the value (indexed by the key Touchpoint id) may contain the following structure:

Subscriber: business entities that requires access to this Touchpoint

Owner: business entity that owns this Touchpoint

Compliance status: whether this Touchpoint is currently compliant

Compliance failure causes: if non-compliant, what are the causes

Depending Touchpoints: ids of other Touchpoint that depends on the compliance status of this Touchpoint

Attribute observations 1512: which contains a time series of observations comprising an Attribute name and an Attribute value. In some embodiments, the Attribute value may be a hash table where the key is a timestamp and the value is a JSON structure.

It should be appreciated, however, that these examples are merely by way of illustration for one particular implementation, as a Touchpoint DB is not limited to any particular structure or format, and in general may be any suitable database that stores data related to Touchpoints.

4.4.4 Basic Policy Check Operation

Policy checking may be implemented by the Compliance Validation Engine 1514 using various suitable techniques. In some embodiments, the Compliance Validation Engine 1514 may have access to one or more Compliance Policy files 1516 (as described above in Section 4.4.1) and one or more Violation Handling files 1518 (as described above in Section 4.4.2). Based on the compliance analysis, the Compliance Validation Engine 1514 may perform one or more actions 1520, such as generating alerts, starting workflow, and/or executing a script.

As an example, in some embodiments, the basic operation of policy checking may be:

Check_compliance(Touchpoint_id, graph_id)

This operation may be for checking the compliance of a particular Touchpoint within a particular supply chain network graph. The operation may be triggered by an explicit invocation from an API. In some embodiments, this operation may be conducted in two phases. A First phase may evaluate each Touchpoint independently against each compliance rule. A Second phase may propagate the compliance status across the supply-chain network.

Each Touchpoint may have the following data structure that keeps track of its compliance check status:

Touchpoint (per type)

Touchpoint id

Owner business entity

Declared compliance: [policyX, policyY, . . . ]

Compliance status

Failed rule: [(policy_name, rule_name), . . . ]

Failed parent: [TouchpointA, TouchpointB, . . . ]

status_changed

One possible non-limiting example of a detailed algorithm is described as follows:

First phase: For each compliance policy, find rules corresponding to the Touchpoint type

For each rule, check the time interval to see if the rule should be evaluated (for explicit API call, this check is not necessary)

If so, check the precondition to see if the rule should be evaluated

If so, evaluate the condition.

If the condition is evaluated to be false, add (policy name, rule name) to the failed_rule. In case the previous status is compliant, set current status to be non-compliant and mark the status of this Touchpoint has changed. Execute the action that is defined for this change.

Else if the condition is evaluated to be true, remove (policy name, rule name) from the failed_rule. In case the previous status is non-compliant and the failure reason now empty, set current status to be compliant and mark the status of this Touchpoint has changed. Execute the action that is defined for this change.

Second phase: Propagate the compliance status of this Touchpoint to every child Touchpoint y

If the status of this Touchpoint x is marked as changed

If this status change of x is from compliant to non-compliant

For each child Touchpoint y

Add (Touchpoint x) to the failed_parent of Touchpoint y. In case the previous status of y is compliant, set current status of y to be non-compliant and mark the status of Touchpoint y has changed. Execute the action that is defined for this change.

Else if this status change of x is from non-compliant to compliant

For each depending Touchpoint y

Remove (Touchpoint x) from the failure_parent of Touchpoint y. In case the previous status of y is non-compliant and its failure reason now empty, set current status of y to be compliant and mark the status of Touchpoint y has changed. Execute the action that is defined for this change.

In addition to an explicit call, the basic operation “check_compliance(Touchpoint_id, graph_id)” may be triggered in the following scenarios.

4.4.5 Periodic Scan for all Touchpoints

This may be done periodically by a configurable time interval. The system may compute a topological sort of all Touchpoints such that Touchpoints will be visited (and checked for compliance) in the order of dependencies (i.e., if node A depends on node B, then node B will be visited before node A).

4.4.6 Check when New Observation Arrives

In some embodiments, for compliance check that has low latency on newly arrived observation, the specific Touchpoint may be checked immediately after receiving new observations.

4.4.7 Check when Changes Happen in Supply Chain Graph

In some embodiments, Touchpoint status may be updated when the supply chain network connectivity changes. For example, when an edge from Touchpoint x to Touchpoint y is removed, no action may be taken. If Touchpoint y has a failed_parent Touchpoint x, it may stay there forever until explicitly removed. When an edge from Touchpoint x to Touchpoint y is added, the compliance status of Touchpoint x may propagate to Touchpoint y in the following way.

If Touchpoint x is compliant, nothing need to be done in Touchpoint y. If Touchpoint x is non-compliant, the system may add Touchpoint x into the failed_parent of Touchpoint y. If Touchpoint y is non-compliant before the connection, then nothing may be done further. If Touchpoint y is compliant before the connection, then Touchpoint y may be marked as non-compliant with change of status true.

In some embodiments, the system may visit every child of node y to further propagate the compliance status changes.

4.5 Scenario Walkthrough of Use Cases

This section illustrates one possible example of how the scenarios described under section 3.1 may be addressed through the design example, according to some embodiments.

4.5.1 Truck Carrying Feed Enters the Security Gate of Farm

In this example, a Truck is a Touchpoint for which compliance is to be ensured, and a Security Gate is treated as a sensor of the Truck.

The guard at the security gate captures the information from the truck driver into an entry log in an electronic form, which will then upload to the IBMS backend via an HTTP/JSON interface as follows:

Sensor Data

```
[
  {
  “header”:
  {
    “touchpoint_id”: “vin12345”,
    “touchpoint_type”: “Truck”
    “sensor_id”: “gate20”,
    “user_id”: “joe”,
    “timestamp”: 1002389
  },
  “body”:
  {
    “driver”: “John Doe”
    “last_location”: {“loc”: “placeX”, “time”: 2000567},
    “last_wash”: 2000620,
    “temperature”: 50,
    “carrying”: [“feed”]
  }
  }
]
```

This observation data may be merged into the corresponding Touchpoint data stored in the Touchpoint repository JSON store.

Touchpoint Repository Data

```
{
“vin12345”: {
  type: “Truck”,
  owner: “truckingCo”,
  connect_to: [“farm24”],
  compliance_status: {
  target_compliance: [“FDA”, “Walmart”],
  failed_rules: [ ],
  failed_parents: [ ],
  last_check: 1001060
  },
  attributes: {
  “driver”: [
    {
    timestamp: 1002389,
    value: “John Doe”
    },
    {
    timestamp: 1001054,
    value: “Peter Pan”
    }
  ],
  “last_location”: [
    {
    timestamp: 1002389,
    value: {“loc”: “placeX”, “time”: 2000567}
    },
    {
    timestamp: 1001034,
    value: {“loc”: “placeY”, “time”: 2000542}
    },
    {
    timestamp: 1000032,
    value: {“loc”: “placeX”, “time”: 2000217}
    }
  ],
  “last_wash”: [
    {
    timestamp: 1002389,
    value: 2000620
    },
  ],
  “temperature”: [
    {
    timestamp: 1002389,
    value: 50
    },
    {
    timestamp: 1001054,
    value: 45
    }
  ],
  “carrying”: [
    {
    timestamp: 1002389,
    value: [“feed”]
    },
    {
    timestamp: 1001052,
    value: [“egg”]
    }
  ],
  “speed”: [
    {
    timestamp: 1001054,
    value: 65
    }
  ]
  }
}
}
```

The compliance engine 1514 may periodically check this Touchpoint according to the following policy:

Compliance Policy (FDA Compliance.txt)

```
TouchpointType:Truck
  # All temperature reading must be less than MAX_TEMP
  rule:TEMP_RULE
    check_interval: 300
    check:
      every(lambda temp: temp < MAX_TEMP, temperature.
      since_last_check( ))
    end_check
  end_rule
  # If it carries feed, it must be washed after visiting a contaminated place
  rule:CLEAN_RULE
    check_interval: 300
    precondition:
      carrying.last( ).value.contains(“feed”)
      len(last_location.all_time( )) > 0
    end_precondition
    check:
      len([x for x in last_location.all_time( )) if
is_contaminated(x[“value”][“loc”]) and x[“value”][“timestamp”] >
last_wash[“value”]]) == 0
    end_check
  end_rule
end_TouchpointType
```

4.5.2 Farm Worker Perform Task on Henhouse

In this case, a farm worker going to a henhouse to measure the weight of 10 chicken, and then also clean some manure pit, may enter identifying information for the pit into a mobile device application, which may upload the following message:

Sensor Data

```
[
  {
  “header”:
  {
    “touchpoint_id”: “hh3”,
    “touchpoint_type”: “Henhouse”
    “sensor_id”: “app201”,
    “user_id”: “John Smith”,
    “timestamp”: 1002389
  },
  “body”:
  {
    “flock_age”: “agegroupA”
    “chicken_weight”: [2.5, 3.2, 3.0, 2.8, 3.2, 3.1, 3.4, 3.1, 2.9, 3.0]
    “manure_pit_cleaning”: [“pit1”, “pit3”]
  }
  }
]
```

This observation data may be merged into the corresponding Touchpoint data stored in the Touchpoint repository JSON store.

Touchpoint Repository Data

```
{
  “hh3”: {
  type: “Henhouse”,
  owner: “farmX”,
  connect_to: [“belt2”, “belt3”],
  compliance_status: {
    target_compliance: [“FDA”, “Walmart”],
    failed_rules: [ ],
    failed_parents: [ ],
    last_check: 1001060
  },
  attributes: {
    “mouse_count”: [
    {
      timestamp: 1002046,
      value: 5
    },
    {
      timestamp: 1001054,
      value: 7
    }
    ],
    “manure_pit_cleaning”: [
    {
      timestamp: 1002389,
      value: [“pit1”, “pit3”]
    },
    {
      timestamp: 1001054,
      value: [“pit1”, “pit2”]
    }
    ],
    “chicken_weight”: [
    {
      timestamp: 1002389,
      value: {
      “flock_age”: “agegroupA”,
      “weight”: [2.5, 3.2, 3.0, 2.8, 3.2, 3.1, 3.4, 3.1, 2.9, 3.0]
      }
    },
    {
      timestamp: 1001034,
      value: {
      “flock_age”: “agegroupA”,
      “weight”: [3.2, 3.1, 3.0, 2.3, 3.6, 3.1, 2.9, 3.0, 2.9, 2.7]
      }
    },
    {
      timestamp: 1000728,
      value: {
      “flock_age”: “agegroupB”,
      “weight”: [3.1, 3.1, 3.0, 2.3, 3.6, 3.3, 2.9, 3.0, 2.8, 2.9]
      }
    }
    ]
  }
  }
}
```

The compliance engine 1514 may periodically check this Touchpoint to make sure the weight measurement is legitimate and that the manure pit is sufficiently clean according to the following policy:

Compliance Policy (FDA Compliance.txt)

```
TouchpointType:Henhouse
  rule:DEVIATION_CHECK
    check_interval: 24*60*60
    check:
      every(lambda weights: stdev(weights) > MIN_VAR _WEIGH,
chicken_weights.last_n_days(2))
    end_check
  end_rule
  rule:MIN_WEIGHT_CHECK
    check_interval: 24*60*60
    check:
      every(lambda weights: mean(weights) > min_weight(flock_age),
chicken_weights.last_n_days(2))
    end_check
  end_rule
  rule:MAX_WEIGHT_CHECK
    check_interval: 24*60*60
    check:
      every(lambda wt: mean(wt) < max_weight(flock_age),
      chicken_weights.last_n_days(2))
    end_check
  end_rule
  rule:PIT_CLEANING
    check_interval: 24*60*60
    check:
      Set([“pit1”, “pit2”, “pit3”]) −
      unfold(manure_pit.last_n_days(7)) == EMPTY_SET
    end_check
  end_rule
end_TouchpointType
```

4.6 Architecture Design Principles

The following are some examples of underlying principles, according to some embodiments. It should be appreciated, however, that these are merely some examples of principles, and all embodiments are not necessarily limited to following these principles.

Simple and Minimal: if there are two architectures where both can handle existing use cases, the simpler one wins.

Every component in the Architecture must be touched by some concrete use case to justify its existence. If unsure how the component will be used, leave it out.

Extensible: new components should be added easily and smoothly as new requirement (use case) pop up, without needing significant change of existing components.

Modular: functionalities are well encapsulated and self-contained

Scalable: each component can scale independently (by adding resources to just that component) as workload pattern changes.

Resilient: no single point of failure.

Integration with external parties: the architecture should introduce minimal changes to existing system that needs to be integrated. In some embodiments, open source packages for non-core functionalities may be utilized.

4.7 Technology Stack and Rationale

This section describes some examples of an underlying technology stack, according to some embodiments. It should be appreciated that these is merely one possible example of a technology stack, and that all embodiments are not necessarily limited to these design choices. In general, a compliance management system may utilize any suitable technique and protocol to implement a technology stack.

4.7.1 Python as Primary Programming Language

Python may be used as a primary programming language because of the following reasons:

Rapid Application Development (RAD)—For business reasons it may be desirable to bring the product to market as soon as possible. Python being compact and dynamically typed may significantly improve the productivity of developers.

Maintainability—Python may produce less lines of code to deliver functionality as compared to traditional server side languages like Java. This may enable less code to be required to be maintained.

Python is an expressive programming language that may improve code readability.

It should be appreciated that other programming languages may be used other than Python. For example, Ruby may be used, since Ruby also comes with a similar set of features. However, in some embodiments, Python may be preferable over Ruby due to simplicity of use, extensive module list and growing acceptability among industry leaders.

If Python is a primary programming language, then Python-Django may be a natural choice as a Model-view-controller (MVC) web framework.

4.7.2 MongoDB as Primary Storage

In some embodiments, “polyglot persistence” may be used, in which an application uses different storage technologies for data persistence based on varying data storage needs. Embodiments are not limited to any particular type of database format, such as NOSQL, but may utilize other techniques, such as RDBMS, through various third party integration tools.

In some embodiments, a NoSQL database may be used for storing high volume observation data that will come in the form of observations either directly send by various sensors or uploaded manually while executing tasks. NOSQL may provide the following advantages in some embodiments:

High Scalability; the cost of scale may be low compared to traditional RDBMS, thus achieving an acceptable economy of scale.

Absence of pre-defined schema enables easy extension of data model.

Better performance for high volume of data.

In some embodiments, if data is stored in JSON format, then a MongoDB format may be used.

4.7.3 Activiti as a Workflow Management System

Some possible options for open source BPM solutions include, but are not limited to: jBPM, Activiti and Bonitasoft.

In some embodiments, Activiti may be an appropriate choice for building a platform because of the following:

It gives full control over the code. In case of Bonitasoft the code is often generated by developer tools. Activiti as well jBPM is developer-oriented process engine and provide API based access to process engine while Bonitasoft provides a tool-based solution.

While in case of Activiti, everything is open source but in case of Bonitasoft many of the advanced features are available through paid subscription.

Activiti provides a customizable simple but advanced web interface (Activiti Explorer) for process and task management.

Activiti and jBPM have a lot in common in terms of architecture and features as Activiti was started by the former author of jBPM thus can be considered as next generation BPM system.

4.7.4 JasperSoft as Reporting and BI Solution

Embodiments are not limited to any particular type of Reporting and BI solution. Some possible options include, but are not limited to, open source solutions such as BIRT, JasperSoft and Pentaho.

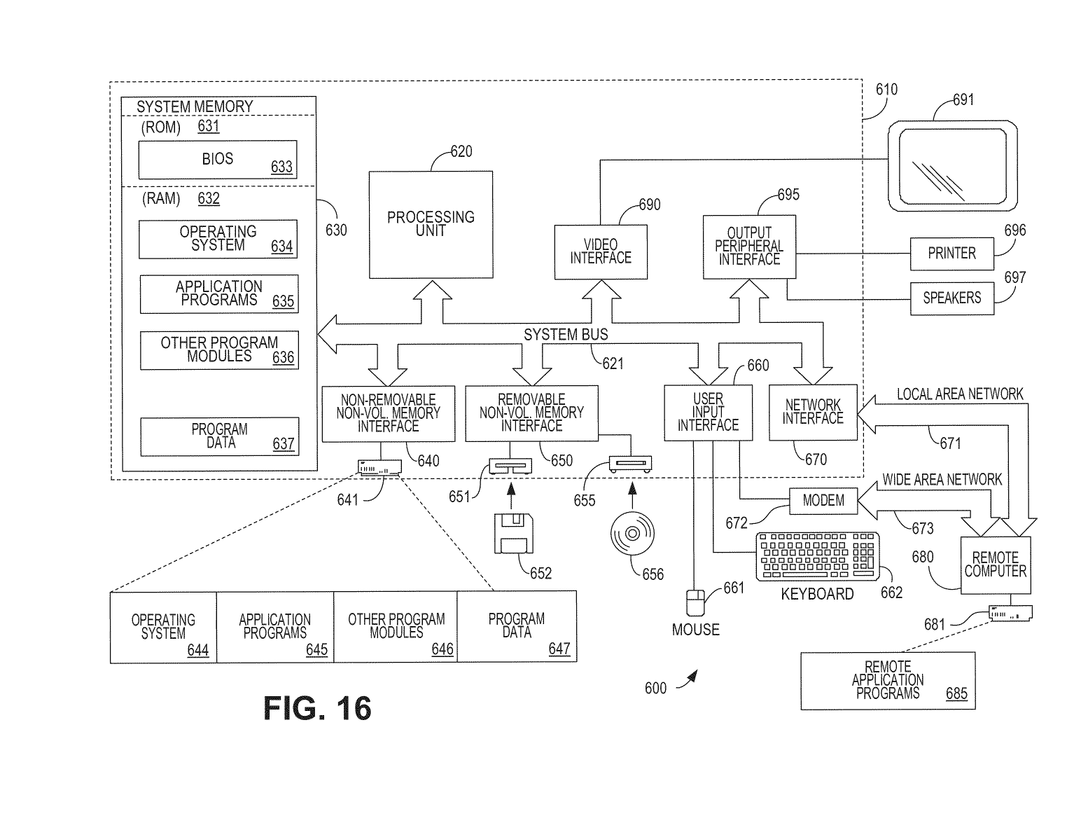

FIG. 16 illustrates an example of a suitable computing system environment 1600 on which the invention may be implemented. This computing system may be representative of a central server (e.g., server 102 in FIG. 1), a sensor (e.g., sensors 110a-110c in FIG. 1), or a reporting device (e.g., reporting devices 114a-114c in FIG. 1). However, it should be appreciated that the computing system environment 1600 is only one example of a suitable computing environment and is not intended to suggest any limitation as to the scope of use or functionality of the invention. Neither should the computing environment 1600 be interpreted as having any dependency or requirement relating to any one or combination of components illustrated in the exemplary operating environment 1600.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 16, an exemplary system for implementing the invention includes a general purpose computing device in the form of a computer 1610. Components of computer 1610 may include, but are not limited to, a processing unit 1620, a system memory 1630, and a system bus 1621 that couples various system components including the system memory to the processing unit 1620. The system bus 1621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1610 typically includes a variety of computer readable media. Computer readable media can be any available media that can be accessed by computer 1610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 1610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 1630 includes computer storage media in the form of volatile and/or nonvolatile memory such as read only memory (ROM) 1631 and random access memory (RAM) 1632. A basic input/output system 1633 (BIOS), containing the basic routines that help to transfer information between elements within computer 1610, such as during start-up, is typically stored in ROM 1631. RAM 1632 typically contains data and/or program modules that are immediately accessible to and/or presently being operated on by processing unit 1620. By way of example, and not limitation, FIG. 16 illustrates operating system 1634, application programs 1635, other program modules 1636, and program data 1637.

The computer 1610 may also include other removable/non-removable, volatile/nonvolatile computer storage media. By way of example only, FIG. 16 illustrates a hard disk drive 1641 that reads from or writes to non-removable, nonvolatile magnetic media, a magnetic disk drive 1651 that reads from or writes to a removable, nonvolatile magnetic disk 1652, and an optical disk drive 1655 that reads from or writes to a removable, nonvolatile optical disk 1656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1641 is typically connected to the system bus 1621 through an non-removable memory interface such as interface 1640, and magnetic disk drive 1651 and optical disk drive 1655 are typically connected to the system bus 1621 by a removable memory interface, such as interface 1650.

The drives and their associated computer storage media discussed above and illustrated in FIG. 16, provide storage of computer readable instructions, data structures, program modules and other data for the computer 1610. In FIG. 16, for example, hard disk drive 1641 is illustrated as storing operating system 1644, application programs 1645, other program modules 1646, and program data 1647. Note that these components can either be the same as or different from operating system 1634, application programs 1635, other program modules 1636, and program data 1637. Operating system 1644, application programs 1645, other program modules 1646, and program data 1647 are given different numbers here to illustrate that, at a minimum, they are different copies. A user may enter commands and information into the computer 1610 through input devices such as a keyboard 1662 and pointing device 1661, commonly referred to as a mouse, trackball or touch pad. Other input devices (not shown) may include a microphone, joystick, game pad, satellite dish, scanner, or the like. These and other input devices are often connected to the processing unit 1620 through a user input interface 1660 that is coupled to the system bus, but may be connected by other interface and bus structures, such as a parallel port, game port or a universal serial bus (USB). A monitor 1691 or other type of display device is also connected to the system bus 1621 via an interface, such as a video interface 1690. In addition to the monitor, computers may also include other peripheral output devices such as speakers 1697 and printer 1696, which may be connected through a output peripheral interface 1695.

The computer 1610 may operate in a networked environment using logical connections to one or more remote computers, such as a remote computer 1680. The remote computer 1680 may be a personal computer, a server, a router, a network PC, a peer device or other common network node, and typically includes many or all of the elements described above relative to the computer 1610, although only a memory storage device 1681 has been illustrated in FIG. 16. The logical connections depicted in FIG. 16 include a local area network (LAN) 1671 and a wide area network (WAN) 1673, but may also include other networks. Such networking environments are commonplace in offices, enterprise-wide computer networks, intranets and the Internet.

When used in a LAN networking environment, the computer 1610 is connected to the LAN 1671 through a network interface or adapter 1670. When used in a WAN networking environment, the computer 1610 typically includes a modem 1672 or other means for establishing communications over the WAN 1673, such as the Internet. The modem 1672, which may be internal or external, may be connected to the system bus 1621 via the user input interface 1660, or other appropriate mechanism. In a networked environment, program modules depicted relative to the computer 1610, or portions thereof, may be stored in the remote memory storage device. By way of example, and not limitation, FIG. 16 illustrates remote application programs 1685 as residing on memory device 1681. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of monitoring, managing, and instrumenting a distributed work environment, the method comprising:
receiving data, wherein the data represents or is related to one or more of
a. behavior of one or more persons responsible for taking action in the distributed work environment,
b. biological or environmental parameters associated with the distributed work environment,
c. operational conditions and/or events,
d. apparatus usage and/or condition,
e. one or more standards and degree of compliance therewith, or
f. product production and/or delivery logistics;
using at least one processor to
process at least part of the data;
determine, based on the processing of at least part of the data, whether a parameter status satisfies at least one standard; and
output at least one result based on determining whether the status satisfies the at least one standard.

2. The method of claim 1, wherein receiving data is performed by using at least one sensor.

3. The method of claim 2, wherein the at least one sensor is configured to detect one or more conditions related to the distributed work environment.

4. The method of claim 2, wherein the at least one sensor is configured to detect a human behavior comprising at least one of a speech, a motion, a location, or an interaction.

5. The method of claim 2, wherein the at least one sensor is dynamically re-configurable based, at least in part, on the at least one result.

6. The method of claim 1, further comprising displaying, using at least one output device, information indicating the at least one result.

7. The method of claim 1, wherein the at least one standard comprises at least one of a governmental regulation, an industry standard, or a company specification.

8. The method of claim 1, wherein the status comprises at least one of a behavioral status, a biological status, an operational status, a machine status, or a logistical status.

9. The method of claim 1, wherein determining whether the status satisfies at least one standard comprises estimating a current and/or future state of the status, based on the processing of the at least part of the data.

10. The method of claim 1, wherein determining whether the status satisfies at least one standard comprises determining whether at least one requirement has been satisfied by an entity involved in the distributed work environment.

11. The method of claim 10, wherein the at least one result comprises information identifying the entity and whether the entity has satisfied the at least one requirement.

12. The method of claim 11, wherein determining whether an entity has satisfied the at least one requirement comprises comparing the data with a predetermined pattern, to determine an indication of a fraudulent and/or erroneous activity.

13. The method of claim 11, wherein determining whether an entity has satisfied a requirement comprises correlating the data representing or relating to behavior of one or more persons with other types of data and performing a comparison with the one or more standards.

14. The method of claim 11, wherein the at least one result further comprises at least one instruction for the entity to satisfy the requirement.

15. The method of claim 1, wherein the at least one result further comprises at least one change in operations of the distributed work environment.

16. At least one computer-readable medium having stored thereon computer-readable program instructions which, when executed by at least one processor, perform acts of:
receiving data, wherein the data represents or is related to one or more of
a. behavior of one or more persons responsible for taking action in the distributed work environment,
b. biological or environmental parameters associated with the distributed work environment,
c. operational conditions and/or events,
d. apparatus usage and/or condition,
e. one or more standards and degree of compliance therewith, or
f. product production and/or delivery logistics;
processing at least part of the data;
determining, based on the processing of at least part of the data, whether a parameter status satisfies at least one standard; and
outputting at least one result based on determining whether the status satisfies the at least one standard.

17. The at least one computer-readable medium of claim 16, wherein receiving data is performed by using at least one sensor.

18. The at least one computer-readable medium of claim 17, wherein the at least one sensor is configured to detect one or more conditions related to the distributed work environment.

19. The at least one computer-readable medium of claim 17, wherein the at least one sensor is configured to detect a human behavior comprising at least one of a speech, a motion, a location, or an interaction.

20. The at least one computer-readable medium of claim 17, wherein the at least one sensor is dynamically re-configurable based, at least in part, on the at least one result.

21. The at least one computer-readable medium of claim 16, further comprising displaying, using at least one output device, information indicating the at least one result.

22. The at least one computer-readable medium of claim 16, wherein the at least one standard comprises at least one of a governmental regulation, an industry standard, or a company specification.

23. The at least one computer-readable medium of claim 16, wherein the status comprises at least one of a behavioral status, a biological status, an operational status, a machine status, or a logistical status.

24. The at least one computer-readable medium of claim 16, wherein determining whether the status satisfies at least one standard comprises estimating a current and/or future state of the status, based on the processing of the at least part of the data.

25. The at least one computer-readable medium of claim 16, wherein determining whether the status satisfies at least one standard comprises determining whether at least one requirement has been satisfied by an entity involved in the distributed work environment.

26. The at least one computer-readable medium of claim 25, wherein the at least one result comprises information identifying the entity and whether the entity has satisfied the at least one requirement.

27. The at least one computer-readable medium of claim 26, wherein determining whether an entity has satisfied the at least one requirement comprises comparing the data with a predetermined pattern, to determine an indication of a fraudulent and/or erroneous activity.

28. The at least one computer-readable medium of claim 26, wherein determining whether an entity has satisfied a requirement comprises correlating the data representing or relating to behavior of one or more persons with other types of data and performing a comparison with the one or more standards.

29. The at least one computer-readable medium of claim 26, wherein the at least one result further comprises at least one instruction for the entity to satisfy the requirement.

30. The at least one computer-readable medium of claim 16, wherein the at least one result further comprises at least one change in operations of the distributed work environment.

31. A method of end-to-end monitoring of a distributed work environment from a starting point to an ending point, the method comprising:
receiving data that emanates from critical points within the distributed work environment;
wherein the data represents or is related to one or more of
a. behavior of one or more persons responsible for taking action in the distributed work environment,
b. biological or environmental parameters associated with the distributed work environment,
c. operational conditions and/or events,
d. apparatus usage and/or condition,
e. one or more standards and degree of compliance therewith, or
f. product production and/or delivery logistics;
using at least one processor to
process at least part of the data;
determine, based on the processing of at least part of the data, whether a parameter status of the distributed work environment satisfies at least one standard; and
output at least one result based on determining whether the parameter status satisfies the at least one standard.

32. The method of claim 31, wherein receiving data is performed by using at least one sensor.

33. The method of claim 32, wherein the at least one sensor is configured to detect one or more conditions related to the distributed work environment.

34. The method of claim 32, wherein the at least one sensor is configured to detect a human behavior comprising at least one of a speech, a motion, a location, or an interaction.

35. The method of claim 32, wherein the at least one sensor is dynamically re-configurable based, at least in part, on the at least one result.

36. The method of claim 31, further comprising displaying, using an output device, information indicating the at least one result.

37. The method of claim 31, wherein the at least one standard comprises at least one of a governmental regulation, an industry standard, or a company specification.

38. The method of claim 31, wherein the status comprises at least one of a behavioral status, a biological status, an operational status, a machine status, or a logistical status.

39. The method of claim 31, wherein determining whether the status satisfies at least one standard comprises estimating a current and/or future state of the status, based on the processing of the at least part of the data.

40. The method of claim 31, wherein determining whether the status satisfies at least one standard comprises determining whether at least one requirement has been satisfied by an entity involved in the distributed work environment.

41. The method of claim 40, wherein the at least one result comprises information identifying the entity and whether the entity has satisfied the at least one requirement.

42. The method of claim 41, wherein determining whether an entity has satisfied the at least one requirement comprises comparing the data with a predetermined pattern, to determine an indication of a fraudulent and/or erroneous activity.

43. The method of claim 41, wherein determining whether an entity has satisfied a requirement comprises correlating the data representing or relating to behavior of one or more persons with other types of data and performing a comparison with the one or more standards.

44. The method of claim 41, wherein the at least one result further comprises at least one instruction for the entity to satisfy the requirement.

45. The method of claim 31, wherein the at least one result further comprises at least one change in operations of the distributed work environment.
